(19) United States
(12) Patent Application Publication
(10) Pub. No.: US 2012/0256422 A1
(43) Pub. Date: Oct. 11, 2012

(54) BROAD-SPEED-RANGE GENERATOR VARIATIONS

(76) Inventor: Richard B. Fradella, (US)

(21) Appl. No.: 13/080,488

(22) Filed: Apr. 5, 2011

(51) Int. Cl. F03D 9/00; F03G 5/06; H02K 7/102; F03B 13/08; H02P 9/48; H02K 9/22

(52) U.S. Cl. 290/55; 322/25; 310/52; 318/372; 290/54

(57) ABSTRACT

A brushless generator with permanent-magnet multi-pole rotor disks and stator winding disks in their axial magnetic field includes integral electronics to efficiently generate regulated DC current and voltage from mechanical input power over a broad speed range. All power for the electronics is provided by rectifier diodes from its stator windings. Differential amplifiers provide stator voltage feedback signals. Its power rating is scalable, depending on the number of its disks. Having no iron cores and no gears, it incurs no cogging torque, and no gear friction. Integral power control electronics includes high-frequency pulse-width-modulated boost regulation, which provides regulated current at requisite voltage over its broad speed range. A main wind-powered embodiment to produce DC power for a constant voltage DC load over a broad speed range includes signal processing so output power varies according to the third power of speed. Combined boost-regulation, zero cogging torque, and no gearing, enable a wide speed range, for better power quality and higher wind energy yields.

### BACKGROUND OF THE INVENTION

1. Field of the Invention

Applicant sets forth herein a brushless DC (direct-current) generator with permanent-magnet rotor disks and stator winding disks responsive to a rotating axial magnetic field in spaces between the rotor disks, including integral electronics, to efficiently generate DC electric power, at current and voltage regulated by the electronics, from broadly variable speed rotary mechanical drive. The present invention includes further variations of generator embodiments set forth in applicant's U.S. Pat. No. 7,646,178 for a “BROAD-SPEED-RANGE GENERATOR”. Said variations are intended to reduce the number of parts needed, and thereby improve reliability, reduce power needed for the integral electronics, reduce the number of conductors between the generator assembly and its power interface electronics, and prevent the generator from drawing power from its DC load without need for electric or electronic parts between the generator and its DC load. Said parts incur power losses that reduce efficiency. It also sets forth a generator variation whereby the generator assembly body rotates, and its tubular shaft is stationary; which facilitates optimum integral wind turbine and generator systems.

Its various embodiments are intended to generate useful electric power efficiently, especially at low speed and torque, from a wide variety of variable speed and torque drive sources. Moreover, the generator variations set forth herein are intended to substantially improve and expand sustainable environmentally responsible energy options, such as wind power, hydrodynamic power, and human-power-assisted electric vehicles. A main embodiment is intended to generate better quality electric power from wind turbines, and higher energy yields, compared to most prior art wind turbine generators.

2. Description of the Related Art

Widely used induction generators, intended to augment grid power by their 3-phase power connections to utility power grids through switch-gear, must presently be limited, because their power disruptions may cause grid failures. Said switch-gear presently disconnects when wind speed is low, to prevent the induction generators from drawing substantial grid power. Unless turbine speed is limited, they may also need to be disconnected at high wind speed, to prevent induction generator over-heating.

Gate-turnoff Silicon Controlled Rectifier (SCR) power switching semiconductors can be included for converting the induction generator poly-phase power to DC. The SCR is a rugged power switch, and can control higher power than comparable cost high-frequency switching semiconductors. However, induction machines have high inductance and high-loss iron cores, so it is not feasible to use a series low-loss ferrite core inductor having relatively low high-frequency losses, as described for the present invention. Induction machine core loss would be very high, with attendant heating problems, if subjected to high-frequency switch-mode pulse-width-modulation (PWM) to provide variable-frequency poly-phase sinusoidal voltages having low harmonic distortion across the induction machine stator winding terminals.

A circuit including a number of SCR power switches, to interface between a DC power bus and a 3-phase induction machine, can generate a variable-frequency sinusoid fundamental. But it has substantial harmonic distortion. The harmonics cause high induction machine losses. Nevertheless, said circuit can extend the speed range over which induction generators can produce DC power. To augment grid power, high-frequency 3-phase power inverters can then convert power from a DC power bus to grid power at requisite phase and minimal distortion. However, such systems are lossy and not self-starting, and require DC power bus storage.

Prior art inventions that provide examples of power interface electronics for variable-speed induction machines that are driven by chemical batteries and regenerate power thereto include: U.S. Pat. No. 5,099,186 by Rippel et al; and U.S. Pat. No. 5,355,070 by Cocconi.

Synchronous AC generators include salient-pole alternators having wound stators and permanent-magnet rotors. Their output voltage and frequency are substantially proportional to their shaft speed. One type of brushless salient-pole reluctance machine has wound stator poles with magnetic bias from permanent magnets. They may include field windings, to afford limited voltage regulation. Homopolar machines are also a synchronous brushless type, with their power output frequency proportional to speed; they have limited voltage adjustment. If their field is derived only from a field winding, they will need electric startup power for that winding.

Cogging torque (wherein the rotor angle aligns its iron core poles and holds minimum magnetic reluctance positions), like stiction and friction in gears, may cause wind turbines to stall at low wind speeds. These shortcomings and too low output voltage at low shaft speeds prevent usable power generation at low wind speeds from this prior art machine. Adding a boost regulator in series with the rectified and filtered alternator type generator output can facilitate higher voltages at low shaft speeds, needed for loads such as chemical batteries. However, the boost regulator incurs tandem losses, and machine cogging may stall the wind turbine driving it so no electric power output is produced from this prior art machine at low wind speeds.

Conversely, the present invention is intended to generate power at requisite voltage through its wide speed range; it will not need electric startup power from its load or any other external source; and it will efficiently generate power from rotation at low speed and torque from low wind speeds, not stalled by generator cogging torque, stiction, or friction. Moreover, the present invention generates optimum power over its wide speed range.

Besides their use for AC power generation in power plants, applications for synchronous generators range widely, usually with their AC outputs rectified, to charge batteries and the like. However, their varying voltage and frequency can be a major disadvantage. Generated and rectified voltage must be sufficient, and usually regulated, to meet needs of given applications. Moreover, very low frequency ripple at low shaft speed requires large filter capacitors, which cost more and have shorter lifetimes than small ceramic or film capacitors. These properties usually limit synchronous generator applications to high shaft speeds. Their cogging torque is another drawback. Peripheral equipment needed for augmenting grid power, from alternators used as generators driven by wind turbines, usually include gears to increase generator shaft speed, rectifiers to convert their AC outputs to DC, and power inverters to convert the DC to regulated AC in phase with the grid. Moreover, their varying output voltage and current must be regulated, for chemical battery charging applications.

Brush-commutated DC generators may have permanent-magnet field excitation. They may also have field excitation windings, for limited output voltage adjustment. Besides shorter lifetimes due to their commutator brush and armature wear, commutator sparking can be troublesome; and, similar to most prior art generators, their DC output voltage is proportional to speed, thus precluding many low-speed applications, unless their output is connected to loads via boost regulator circuits. Alternatively, their varying output voltage and current may require a buck regulator, between the generator output and its load. Such external and series electronics reduces overall power efficiency, particularly at low turbine speeds.

Regardless of said drawbacks, these machines are used as generators for many applications. Peripheral equipment, for use as generators driven by wind turbines, may include speed-up gearing and output rectifiers. Said rectifiers may be needed, to prevent power from a DC power-bus load, which it feeds, such as chemical batteries it is meant to charge, from driving said DC generator as a motor, and discharging connected batteries whenever the generator output voltage is less than the battery voltage. Power regulator circuits, such as battery chargers, are usually needed. Besides these limitations, brush-commutated generators also need periodic commutator maintenance; their commutators are damaged with use, by wear and sparking.

Gearing needed to increase prior art generator speed, so prevalent in wind power systems, also needs bearings for the gears, is subject to wear, needs lubricant cooling and periodic maintenance, and incurs substantial power losses. Cogging torque and gear stiction further inhibits and usually prevents power generation at low wind speeds. Conversely, the present invention, having no cogging torque and no speed-up gearing, efficiently generates optimum power from wind turbines over a wide speed range, controlled by its electronics.

Most electric motors can be used as generators. There is fundamentally no difference, between most prior art motors and generators, of a specific type, except for how they are used to meet needs of specific applications. For example, an induction machine can serve as an induction motor or as a generator. Motors used in ubiquitous machinery, tools, and appliances can be configured mechanically and electrically as generators.

Insofar as drive speed and torque is regulated at steam driven and large hydroelectric power plants, the prior art generators described above have provided acceptable options, to generate most of the electric power that is distributed by power grids, for over a century.

Smaller and portable versions of said generators, driven by fuel-burning engines, also serve viable small markets. However, need for wider speed range has been long recognized.

Some prior art inventions teach methods to accommodate variable-speed drives, by means substantially different from applicant's present invention:

U.S. Pat. No. 5,021,698 “Axial Field Electrical Generator” by Pullen et al, describes a high-speed generator assembly substantially different from the present invention, and does not describe electronics.

U.S. Pat. No. 5,245,238 “Axial Gap Dual Permanent Magnet Generator” by Lynch et al, describes means for generating constant output voltage that do not include electronics similar to the present invention. Its generator assembly and rotor disks are also distinctly different from those herein described in all embodiments of the present invention.

U.S. Pat. No. 5,982,074 “Axial Field Motor/Generator” by Smith et al and applicant's U.S. Pat. No. 4,530,200 teach, with some differences, a motor/generator assembly having multi-pole axial magnetic field rotor disks and stator disks between them. But they do not set forth electronics similar to the present invention, which efficiently generates regulated DC electric power over a broad speed range and never draws power from DC loads connected thereto.

U.S. Pat. No. 6,969,922 “Transformerless Load Adaptive Speed Controller” by Welches, includes electromechanical means, to obtain constant speed generator drive, from a variable-speed drive source. Its generator assembly is substantially different from the present invention, and it does not teach electronics similar to the present invention.

U.S. Pat. No. 7,190,101 “Stator Coil Arrangement for an Axial Airgap Electric Device Including Low-Loss Materials” by Hirzel, teaches a substantially different generator assembly and materials, and does not set forth electronics similar to the present invention.

U.S. Pat. No. 6,217,398 “Human-Powered Or Human-Assisted Energy Generation And Transmission System With Energy Storage Means And Improved Efficiency” by Davis; and U.S. Pat. No. 7,021,978 “Human-Powered Generator System With Active Inertia And Simulated Vehicle” by Jansen; describe means to use variable effort pedal power. They teach using electric generators with operator adjustable control means, and their advantages over mechanical drives, for augmenting vehicle power, in applications including electric vehicles, watercraft, and the like. However, they do not teach generator assembly configurations nor an electronics power interface as set forth in the present invention.

Other exemplary patents for rotary dynamoelectric machines which provide illustration from which their teachings are incorporated herein by reference, include: U.S. Pat. Nos. 295,534 by Frick; 459,610 by Desroziers; 1,566,693 by Pletscher; 2,743,375 by Parker; 2,864,964 by Kober; 3,050,650 by Baudot; 3,069,577 by Royal; 3,090,880 by Raymond; 3,091,711 by Baudot; 3,219,861 by Burr; 3,230,406 by Baudot; 3,231,807 by Willis; 3,239,702 by Van De Graaff; 3,304,598 by Baudot; 3,375,386 by Hayner et al; 3,401,284 by French; 3,407,320 by Mclean; 3,441,761 by Painton et al; 3,584,276 by Ringland et al; 3,899,731 by Smith; 3,982,170 by Gritter et al; 4,207,510 by Woodbury; 4,228,391 by Owen; 4,371,801 by Richter; 4,384,321 by Rippel; 4,394,597 by Mas; 4,415,963 by Rippel et al; 4,417,194 by Curtiss et al; 4,426,613 by Mizuno et al; 4,513,214 by Dieringer; 4,618,806 by Grouse; 5,117,141 by Hawsey et al; 5,289,361 by Vinciarelli; 5,341,075 by Cocconi; 5,514,923 by Gossler et al; 5,525,894 by Heller; 5,705,902 by Merritt et al; 5,712,549 by Engel; 5,717,303 by Engel; 5,729,118 by Yanagisawa et al; 5,798,591 by Lillington et al; 5,977,684 by Lin; 6,011,337 and 6,049,149 by Lin et al; 6,137,187 by Mikhail et al; 6,246,146 by Schiller; 6,259,233 and 6,407,466 by Caamano; 6,815,934 by Colley.

Patents by applicant, the teachings which are additionally incorporated herein by reference, include: U.S. Pat. Nos. 4,085,355 and 4,520,300 and 6,566,775 and 6,794,777 and particularly 7,646,178 by Fradella.

### OBJECTS OF THE INVENTION

More cost-effective generators that can produce higher energy yields from variable speed and torque rotary power from wind turbines can help to solve critical global energy needs and environmental problems, and improve global economies. Broad-speed-range generators having such useful attributes can enable vast sustainable power systems, without shortcomings associated with prior art power generators. A few such examples are described next.

An important objective of the present invention is to generate maximum high-quality electric power from wind turbines in variable-speed winds. Applicant's present invention generator can convert variable rotary power to usable electric power having regulated current and voltage. An embodiment for wind power efficiently generates constant voltage DC power that is proportional to the third power of speed, over a broad speed range. It would greatly enhance power quality and produce more than double most prior art generator electric energy yields from wind, by harvesting electric power during prevalent low wind speeds and continue to harvest electric power over the entire wind speed spectrum. Variations described herein provide further improvements over embodiments described in applicant's U.S. Pat. No. 7,646,178.

Scalability from multiple-disk generator assemblies facilitates optimal wind turbine loading, without incurring re-tooling expenses to achieve a broad power rating range. The importance of optimal loading is best explained by considering extreme mismatch between a wind turbine and the generator it drives: Potential wind turbine output power is not substantially harvested if generator loading is so slight that the wind turbine coupled to it has minuscule torque load. Conversely, output power is zero when generator loading is so high that it causes the wind turbine to stall. Those versed in the art of generating electric power from wind turbines know that potential wind turbine output power as a function of wind speed is a continuous function, whose maximum power yield requires optimal loading, facilitated by matching a generator to the wind turbine that can best drive it, over a broad wind speed range. Said speed and load scaling and matching is a primary attribute of the present invention, in addition to its reduced number of parts compared to its prior embodiments taught in U.S. Pat. No. 7,646,178.

Alternate embodiments of the present invention include a generator that can convert variable-speed pedal power from a recumbent cyclist, in an electric vehicle, that charges onboard batteries and thereby extends the practical vehicle range, while affording a healthy exercise option. Yet another alternate embodiment has a non-rotating tubular shaft wherein stator conductor terminations emerge for connection to power interface electronics, with an outer rotor generator body connected to mechanical drive elements. Its stator disks are affixed to the tubular shaft. Stator terminals emerge from the stator disk inside diameters, through the tubular shaft.

Accordingly, a general objective of the present invention is to provide a generator, which does not require speed-up gearing to increase its shaft speed, and which has zero cogging torque. A main objective is to provide a generator, which can efficiently generate better quality electric power, with controlled current and voltage, especially at very low shaft speeds, over a very broad speed range. It also should facilitate optimal wind turbine loading. Its shaft or body would preferably be powered by wind turbines having means to limit maximum speed by varying blade pitch or deflecting wind from the blades when a desired maximum speed is reached. When that is not feasible, or if the load cannot accept unregulated power, a friction brake or slip clutch may be added to limit generator rotation speed.

Power generation from wind turbines is expected to be a major application for the present invention. Since optimum-energy-yield turbine shaft speed is proportional to wind speed, and shaft torque proportional to wind speed squared, loading the turbine shaft and outputting electric power so it is proportional to the third power of shaft speed, will extract maximum power over a very broad wind speed range, from essentially all types of wind turbines.

Accordingly, a specific objective for a primary embodiment of the present invention, especially at relatively low typical wind speeds, is to regulate output current and voltage, so that useful regulated electrical output power is proportional to the third power of shaft speed.

An objective of another version is to provide a variable speed generator responsive to user selected torque settings, which can efficiently generate electric power at requisite voltage, from human power, to pedals driven by a driver who would benefit from recumbent cycling exercise. This would also increase driving distance range and thereby appreciably enhance ultra-light electric road vehicles having on-board batteries and a plug-in charger, photovoltaic exterior top surfaces, and brushless regenerative ultra-efficient motors in wheels, which include radially-compliant springs to hold light-weight relatively large diameter tire rims. Such an electric road vehicle is one of many examples of practical, sustainable, non-polluting, low-cost transportation means that do not burn fuel, which would be enhanced by the present invention generator.

Yet another objective of the present invention is to minimize its number of parts, and thereby increase its reliability and reduce its production cost; and never draw power from its DC power load, without need for electric parts between the generator constant voltage DC output and its load, nor losses incurred by said electric parts.

Means to achieve said objectives and attributes of the present invention are described and illustrated herein, by explanations that will be clear to multi-disciplinary scientists and engineers, aerodynamicists, and those versed in the art of power electronics and electric power generators. It will be understood that those versed in these arts can apply various other implementations and parts, to achieve the means and functions described herein.

### BRIEF SUMMARY OF THE INVENTION

The present generator invention is intended to provide useful electric power, from rotary mechanical power, over a very broad speed range, by combining a coreless (i.e., having no salient high-permeability iron cores) permanent-magnet assembly, with integral switch-mode high-frequency boost-regulation power electronics to control its stator winding current while it produces power at requisite DC voltage. This coreless assembly is constituted by axial-field rotor magnets, affixed within rotor disks, forming an alternated pole circular array. With rotation, the magnets provide a time-varying magnetic field pattern that interacts with preferably 2-phase stator windings in the assembly. Said windings are connected to integral PWM (pulse width modulation) high-frequency-switching control electronics in a boost regulator configuration.

Substantially sinusoidal voltage generated, across the stator winding terminals, has amplitude and frequency proportional to rotor disk rotational speed. Said voltage causes current in the stator windings and a series inductance, controlled by PWM power-switching transistors, in series with the windings and the inductance when ON, that are switched ON/OFF at a high frequency. When the transistors are switched ON, the stator voltage causes current to increase through the series inductance. Then, each time the transistors are switched to OFF, free-wheeling diodes provide an alternate path to high-frequency filter capacitors in parallel with a DC load, for resulting high-frequency current pulses, sustained by the series inductors. Current through the stator windings and series inductance is thus controlled by high-frequency PWM switching, so it is substantially sinusoidal, in phase with the voltage across the stator windings, and includes an inherent (preferably very small) triangular-wave component at a relatively high PWM ON/OFF switching frequency. Power for the electronics is provided by rectifier diodes, also connected to the stator windings, so it never draws power from its DC load.

At low rotation speeds, voltage across stator windings that is substantially sinusoidal with time, has correspondingly low amplitude. PWM ON/OFF boost regulation causes relatively high common-mode voltage to be superimposed on the stator winding voltage. Differential amplifiers respectively connected across the stator winding terminals, having high common-mode rejection properties, detect the voltage difference across stator terminal pairs.

An explanation of differential amplifier operation is presented in an Electronic Design magazine Aug. 30, 1963 issue. The reference therein is entitled “Isolating the Causes of Common-Mode Noise” by R. B. Fradella.

Applicant's present invention sets forth circuit variations, including the differential amplifiers that provide stator voltage signals for processing, intended to reduce total number of parts and thereby reduce power dissipated in the electronics and increase reliability.

Current pulses through the power output rectifier diodes, from each of the 2 phases, are filtered mainly by high-frequency capacitors, and may also include a small series inductor between the capacitors and the DC load. The filtered current from each phase is substantially a sinusoid, having a frequency double that of the sinusoidal stator voltage and current, and a DC average half the rectified sinusoidal current peak value. Said rectified sinusoidal currents from each phase have opposite polarities relative to each other. Thus, when the current from one phase is at its peak, current from the other phase is zero.

Main system elements, variations, and combinations, of the present invention, include:
(1) Rotor magnets arrayed in rotor disks, to provide a rotating nearly sinusoidal axial field pattern to each phase of coreless stator windings in stator disks, that generate stator voltage as the rotor spins, without magnetically cycling iron or magnets in their closed magnetic flux paths, and thus not incurring magnetic hysteresis losses and cogging torque.
(2) Stator voltage sensors, each having a differential amplifier with its two inputs across a respective stator winding, corresponding to a respective stator conductor phase, to each provide an alternating nearly sinusoidal feedback signal having amplitude proportional to rotor speed, processed by integral signal-conditioning electronics to control respective stator winding current.
(3) Current sensors, to each provide a respective current feedback signal over a very broad dynamic range, corresponding to respective stator conductor current.
(4) Signal processing electronics, responsive to stator voltage and current sensors, and to DC voltage feedback, to control stator current by PWM and thereby efficiently generate regulated DC current and voltage, from wide speed range rotational power, by boost regulation (fly-back inductor and free-wheeling diode pulse current generation and rectification filtered mainly by high-frequency pulse averaging capacitors).
(5) Rectifier diodes and filter capacitors to supply DC power to the integral electronics, at a DC voltage approaching the peak stator voltages and essentially equal to the DC load voltage during PWM boost regulation, so the generator never draws power from its DC load.
(6) A generator assembly variation, wherein its rotor disks extend to the generator body outside diameter and its stator disks are affixed to a non-rotating tubular shaft through which stator conductor connections are made to integral power interface electronics.

Improvements to the prior art, including parts reduction and power reduction for electronics, compared to generator embodiments taught in U.S. Pat. No. 7,646,178 will be apparent to those versed in the art and in the various engineering disciplines encompassed by it, from the following description of the invention, when considered in conjunction with the accompanying drawings, wherein:

### BRIEF DESCRIPTION OF THE SEVERAL VIEWS OF THE DRAWINGS

FIG. 1 illustrates the main features of applicant's present invention power interface electronics, by a functional block diagram and schematic, which concisely conveys its integrated system elements. A main variation includes rectifier diodes that provide power to integral Power Control Electronics so no power is ever drained by it from the load it supplies.

FIG. 2 illustrates the main features of a present invention embodiment intended as a generator for use with wind turbines, by a detailed functional circuit schematic of the Power Control Electronics shown in FIG. 1.

FIG. 3 illustrates the main features of a present invention embodiment intended mainly as a generator for use with human-power-assisted electric vehicles, by a detailed functional circuit schematic of a different version of the Power Control Electronics shown in FIG. 1.

FIG. 4 shows a typical wind speed Rayleigh statistical distribution, normal wind turbine mechanical power as a function of wind speed, normal power multiplied by duration as a function of wind speed, and resulting predicted available wind turbine energy yield over the broad wind speed range shown.

FIG. 5A illustrates a detailed cross-sectional view of a vertical spin axis present invention generator assembly, intended mainly for vertical-axis wind turbines.

FIG. 5B shows an isometric projection view of the vertical spin axis generator assembly shown in FIG. 5A.

FIG. 6A illustrates a detailed cross-sectional view of a horizontal spin axis present invention generator assembly, intended for horizontal-axis wind turbines and general applications.

FIG. 6B shows an isometric projection view of the horizontal spin axis generator assembly shown in FIG. 6A.

FIG. 7A-B illustrates two among many options of a non-ferrous rotor disk in the generator assembly, each having a circular array of spaces to hold affixed therein an even number of axial-field magnets having axial magnetic polarity that alternates with rotor angle.

FIG. 8A illustrates the electrically non-conductive, thermally conductive, body of each stator disk, including space within it for holding and connecting to two stator windings.

FIG. 8B illustrates two stator windings, each pre-formed to fit axially abutted to each other, preferably with their radial segments in the same axial plane, to minimize axial space needed for the radial segments, within the stator disk shown in FIG. 8A.

FIG. 9 shows a differential amplifier circuit to provide a signal for the Power Control Electronics corresponding to voltage generated across one stator winding phase.

FIG. 10A shows representative 2-phase stator voltages as a function of time, wherein peak amplitude Vₛ is proportional to frequency w, which is proportional to rotational speed.

FIG. 10B shows representative 2-phase stator currents as a function of time, wherein peak amplitude Iₛ is controlled in wind-power generators by PWM to be proportional to the square of frequency w, which is proportional to rotational speed.

FIG. 10C shows representative rectified and filtered 2-phase stator currents as a function of time, wherein peak amplitude Iₐ is controlled in wind-power generators by PWM to be proportional to the third power of frequency w, which is proportional to rotational speed.

FIG. 11 illustrates a mechanical assembly variation wherein the rotor disks extend to a rotatable outside diameter and the stator disks are affixed to a non-rotating tubular shaft from which connection to stator windings can be made. An integrated 3-blade axial wind turbine and generator is shown, which does not require turbine-to-generator shaft coupling mechanisms, and minimizes total bearing power losses and mechanical cogging otherwise incurred by their friction.

FIG. 12A shows a circuit, supplied by rectifier diodes from the generated stator voltage, for supplying +8 volts, −8 volts, and +5 volts to the Power Control Electronics.

FIG. 12B shows a circuit, supplied by rectifier diodes from the generated stator voltage, for supplying +5 volts and nominally +8 volts to the Power Control Electronics.

### DETAILED DESCRIPTION OF THE INVENTION

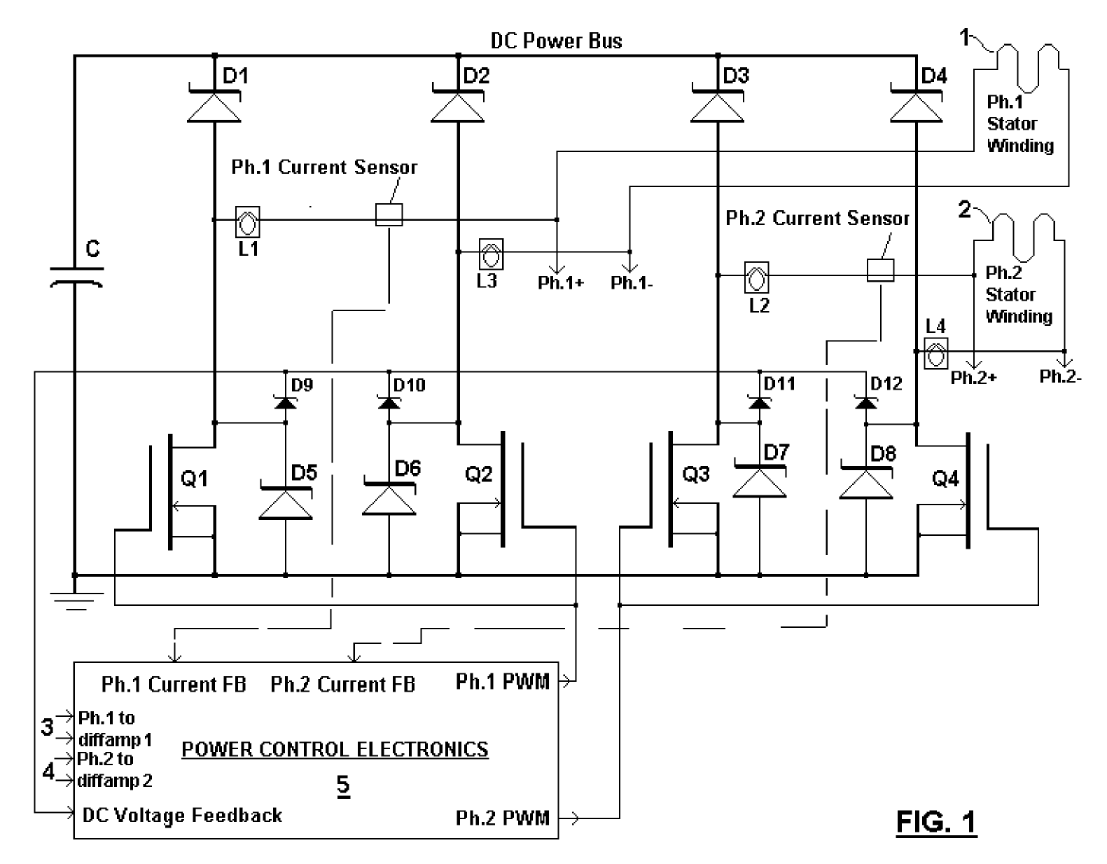

Main elements and combinations of new generator variations are set forth herein. Integral electronics showing the main circuit variations are illustrated in FIG. 1. Features taught in prior art, with new differences and improvements facilitated by variations set forth herein, are briefly described, to explain differences and to provide clear comparisons. While dimensions, component values, tolerances and the like are presented throughout this document to facilitate better understanding of the design of the preferred embodiment, it will be understood that other dimensions, tolerances and the like are additionally contemplated and will be clearly apparent to those versed in the appropriate arts and sciences.

Main elements and combinations of the present invention are set forth herein and illustrated in FIG. 1. The generator system variations described provide unique new combinations of a coreless axial-field generator and cooperative power control electronics having similarities and differences to embodiments set forth in applicant's U.S. Pat. No. 7,646,178. Both are axial-field generators with a closed magnetic field, produced by a circular array of alternated pole axially magnetized permanent magnets, affixed within two or more rotor disks. This magnetic field interacts with pulse-width-modulation (PWM) controlled preferably 2-phase current through its 2-phase radial stator winding segments, in one or more coreless stator disks juxtaposed between two or more rotor disks.

Since the stator windings are not surrounded by high-permeability iron cores, forces due to current through their radial segments, interacting with the magnetic field, act directly on the stator windings. In contrast, most other prior art generators have forces that act mainly on iron core poles. Disks holding the stator windings of the present invention are non-magnetic and electrically non-conductive.

The stator disks must have sufficient thermal conductivity to transfer heat due to stator current copper losses, from the stator windings to the generator exterior. Additive molding materials and methods to increase thermal conductivity of electrically non-conductive materials are broadly available from many commercial sources. Powdered aluminum is one exemplary and widely used additive, which is mixed with injection-molded resins. The small aluminum particles are pre-treated so a thin non-conductive surface layer covering each particle insulates it from adjoining particles, resulting in an electrically non-conductive stator disk that has relatively high thermal conductivity.

The generator assembly design and manufacturing processes of the present invention enables stator disks having considerably higher and consistent thermal conductivity, compared to other electrically non-conductive materials. Moreover, these generator assemblies are readily scalable, by varying their number of rotor and stator disks, to optimize load matching with various turbines while minimizing production and inventory costs.

Most significantly, this generator system does not incur cogging torque, magnetic hysteresis power loss, and eddy loss that would otherwise result from iron cores of most prior art salient pole generators. With integral electronics boost regulation, relatively large diameter rotor and stator disk assemblies, and relatively large number of poles thereby facilitated, need for speed-up gearing is also obviated. Most prior art generators incur cogging torque and gearing stiction that prevent shaft rotation at the low torque levels produced at low wind speeds, so said prior art can generate electric power only during high wind speeds. Therefore, most prior art generators relinquish power over a prevalent wind speed range. Conversely, the present invention provides steady power having both current and voltage control, compared to prior art generators that too frequently need to be disconnected or generate high power bursts with no current or voltage control. These power characteristics are known by electrical engineers and by the electric power industry as factors that determine merit and a measure of power quality.

Stator winding radial segments of the present invention are in a magnetic field varying with both position and time (whereas, in most prior art generators, the magnetic field flux is mainly confined within surrounding iron poles). Therefore, the stator winding conductor options are a design trade-off, between spiral Litz wire having many individually insulated strands, so it does not incur substantial eddy losses as the rotor spins, and single-strand magnet wire. Besides lower eddy losses, multi-strand wire is easily formed, without specialized tooling. However, spiral Litz wire, and a sleeve around it, has a substantially larger diameter than equivalent wire-gauge single-strand magnet wire, and is considerably more costly. Moreover, eddy loss in stator conductors is not a significant problem at low rotor speeds (where maximum generator efficiency is most important). Therefore, single-strand magnet wire, formed by new methods enabled by the new stator disk geometric details of the present invention, may provide a compact lower cost option. The stator windings will preferably be preformed so that radial segments of each phase have the same axial position, and then placed in a mold. Magnet wire having a square cross-section is preferable over a round cross-section, mainly because it accommodates about 20% more copper area in a given space. This procedure will minimize axial space needed for stator conductors and thus maximize magnetic field in that space from the rotor magnets.

Additionally, the present invention includes integral electronics, to enable high-efficiency controlled output current and voltage, over a wind-speed range of about 10-to-1 for 48-volts maximum stator winding voltage. For wind turbine drives having no means to limit speed, whence the generator stator winding peak voltage (generated by shaft rotation) exceeds the desired DC output voltage, chemical battery or flywheel battery loads that can accept unregulated current will cause generator torque to increase and thereby help to limit turbine speed, within stator winding and power electronics temperature and current limits. However, turbine speed limiting preferably by variable-pitch blades or external air flow diverters, as part of a building-integral system, would be best.

A higher output voltage version of circuits described herein can provide high quality, current regulated 3-phase power, synchronized at a desired phase shift, to a 3-phase power grid. That version would require a commercially available DC-to-AC 3-phase power inverter, which can be added between the generator DC power bus and the 3-phase power grid supplied by the generator. It can be shown that DC current drawn by 3-phase inverters producing sinusoidal outputs draw DC current having essentially no 60-Hz or 120-Hz ripple components from their DC power bus supply. However, said current will be drawn as high-frequency PWM pulse current, requiring additional high-frequency filter capacitors across the DC power bus.

Conversely, a single-phase 60-Hz power inverter draws current (I_{DC})*[1+sin(wt)], where frequency (w) is 120-Hz. This requires a relatively large capacitance, to filter the sinusoidal component of current drawn from DC sources that are effectively current-regulated, such as photovoltaic solar panels, and the flywheel batteries described in applicant's U.S. Pat. Nos. 6,566,775 and 6,794,777. For sinusoidal 60-Hz peak output voltage V_{ac}, a single-phase inverter provides a regulated sinusoidal peak current I_{ac} to augment AC line power, which is synchronized to the AC line voltage. With adequate capacitance across the generator DC power bus, to filter the 120-Hz current component drawn from the generator DC power bus, it can be shown that (I_{DC})*(V_{DC})=(0.5)*(I_{ac})*(V_{ac}).

The same generator mechanical assembly of applicant's present invention, combined with power control electronics different from the electronics set forth herein, can function as a variable-speed reversible brushless regenerative motor. Detailed descriptions of such motor system configurations are taught in applicant's U.S. Pat. No. 4,085,355 “Variable-speed Regenerative Brushless Electric Motor and Controller System”, and U.S. Pat. No. 4,520,300 “Brushless Ultra-Efficient Regenerative Servomechanism,” the contents of each which are incorporated hereinabove by reference.

The general embodiment of applicant's present invention is illustrated by FIG. 1, which shows integration of the generator assembly, electronics components connected thereto, and power control electronics. It is applicable to all embodiments of the present invention. Equations shown below describe it quantitatively.

With reference to FIG. 1, Phase 1 stator current is controlled by pulse-width-modulated (PWM) Q1 and Q2 switching; concurrently with like Phase 2 stator current control by Q3 and Q4. The 2-phase current control circuits, connected to a DC power bus, by diodes D1, D2, D3, and D4, result in PWM pulse currents that, when PWM pulses are filtered, are equal to Iₐ sin² (wt) from Ph.1 stator winding 1 and Iₐ cos² (wt) from Ph.2 stator winding 2. Said filtered bus currents combine so generated currents are Iₐ=VₛI_{S}/V_{DC}, with virtually zero ripple component. Electrical frequency (w) is proportional to rotor spin speed, which may vary over a nominal 10-to-1 power generating speed range. The 2-phase circuits in FIG. 1, including high-frequency preferably ferrite core inductors L1, L2, L3, L4, plus Ph.1 and Ph.2 current sensors, along with their power control electronics, are known in the art as boost regulators. Prior art generators, intended to supply DC current (and only at relatively high speed over a narrow speed range), need costly large filter capacitors. The present invention obviates need for such capacitors, by combining (after high-frequency PWM regulated current pulse filtering) current from the respective 2 phases, substantially Iₐ sin²(wt)+Iₐ cos²(wt)=Iₐ.

Inductors L3 and L4 were not included in the generator electronics of applicant's U.S. Pat. No. 7,646,178 because Hall sensors included therein are not susceptible to common-mode voltages, whereas high common-mode voltage pulses can corrupt signal integrity of differential amplifiers included in the present invention generator variations. Including L3 and L4 reduce common-mode voltage by half, of differential amplifiers sensing respective stator voltages Ph.1+ relative to Ph.1− and Ph.2+ relative to Ph.2−, compared to including only L1 and L2. However, these additional inductors will generally be omitted for most generator variations, especially for generator versions producing relatively low output voltage such as 48 vdc, because the added inductor cost and electronics enclosure space needed for them is almost double the versions that include only one inductor per stator phase.

Rectifier diodes D9, D10, D11, and D12 are included in FIG. 1 to rectify stator voltage for the generator electronics, which provides its startup power at a DC voltage equal to the peak stator winding voltages minus the D9-D12 forward conduction voltage drop. To the extent that forward voltage drops of diodes D1-D4 relative to D9-D12 are essentially equal, the rectified stator voltage for the electronics tracks the DC power bus voltage when the generator is supplying power to the DC power bus. Thus, the generator is self-starting when the rectified stator voltage exceeds Q1-Q4 gate driver under-voltage-lock-out (UVLO) levels. The main benefit from this variation is that the generator never draws power from its DC power bus load, and it does not require added series circuit components to block current from the DC power bus load to the electronics.

Current through stator windings 1 and 2 are essentially in phase with voltage generated in the respective windings, due to PWM current control, responsive to signals from the differential amplifiers that sense voltage across stator windings to provide respective feedback signals to control current of each phase. Stator voltages are generated across very low inductance stator windings denoted 1 and 2 in FIG. 1. Signal processing electronics in Power Control Electronics 5 combine stator voltage feedback 3 and 4 from respective differential amplifiers with control variables specific to the various embodiments of the present invention. The resulting signals, applied to two respective minor-loop current feedback circuits, having negative feedback denoted Ph.1 Current FB and Ph.2 Current FB, produce signals that control respective Ph.1 PWM and Ph.2 PWM gate drivers. The PWM gate driver outputs drive Q1 and Q2 power MOSFET gates synchronously, at variable PWM duty-cycle Tₒₙ/(Tₒₙ+T_{off}) to attain desired current in Ph.1 Stator Winding 1. Meanwhile, Q3 and Q4 gates, are likewise driven synchronously, to attain desired current through Ph.2 Stator Winding 2. Said current control can be attained only when the DC Power Bus voltage exceeds the maximum level of peak voltage generated across respective stator windings. Nearly sinusoidal current and voltage waveforms from each 2-Phase stator winding terminal pair, as a function of time, produces averaged current (from capacitor filtered high-frequency PWM current pulses from D1-D4) fed to the DC power bus. The combined averaged currents, fed to the DC power bus, have effectively zero ripple components when peak stator voltage is less than the DC power bus voltage.

Whenever the maximum voltage generated across respective stator windings exceeds the DC Power Bus voltage, the generator will charge capacitors in parallel with the DC Power Bus, and the rectified voltage applied to the electronics, to substantially the stator winding voltage peaks, by full-wave rectifiers from each stator phase, unless the DC bus load can accept unregulated current and still maintain desired DC bus voltage. Since unregulated current and voltage may result in damage to the generator and its load, speed limiting is very desirable to achieve high generator efficiency over a broad speed range. Systems with no speed limiting require components that compromise long-term generator energy yields, to accommodate very infrequent high wind speeds without turbine or generator damage, or even destructive power to the generator load.

For higher voltage systems such as supplying power to a utility grid, Q1-Q4 and D1-D12 and capacitance C voltage ratings must be accordingly increased, along with the voltage regulator for the signal processing circuit. DC-to-DC buck regulators are available commercially. They achieve regulated DC output voltages at various power levels, at about 95% efficiency, by straightforward PWM circuit means. DC-to-AC power inverters can also provide buck-regulation, at about 95% efficiency. Preferably, said inverters would be poly-phase, and synchronized to grid power lines they would feed. Single-phase inverters would draw current having very high ripple, from the DC Power Bus. So they would not be a favorable peripheral for use with this generator. With buck regulation inverters, the DC Power Bus voltage, fed to the DC-to-AC inverters, must be greater than the peak AC voltage on the power grid fed by the generator. Otherwise, a transformer is required for each phase, with turns ratio equal to the inverter/grid voltage ratio.

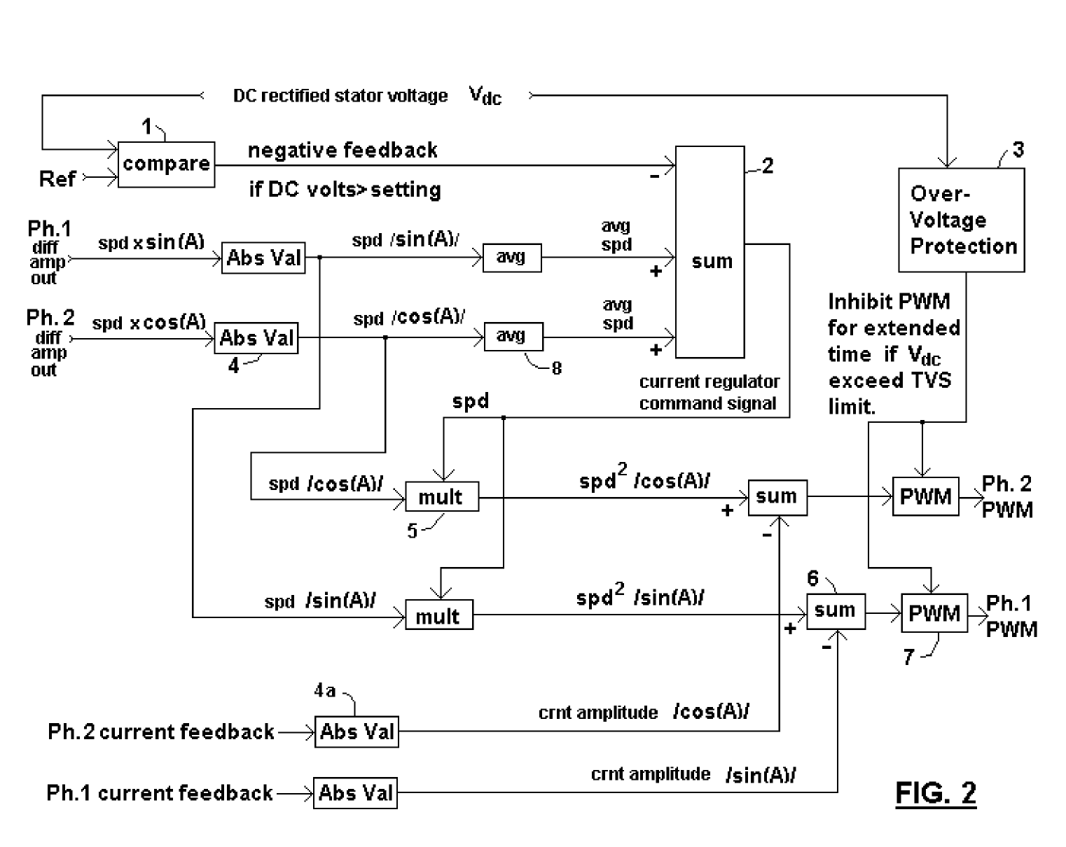

A preferred embodiment of the Power Control Electronics 5 in FIG. 1 is illustrated by the functional block diagram FIG. 2. It is configured as a generator for wind turbines preferably having means to limit rotation speed by varying their blade pitch or limiting wind-speed channeled to them by exterior means.

Stator voltage of the generator variations described herein is proportional to speed. So voltage from Ph.1 can be represented by spd×sin(A) and voltage from Ph.2 by spd×cos(A). The Compare function block 1 in FIG. 2 may be implemented by a differential amplifier circuit, including means that inhibits negative voltage feedback from the DC rectified stator voltage V_{dc}, unless V_{dc} exceeds a prescribed voltage reference (Ref) setting. Ph.1 stator voltage sensor feedback signal spd×sin(A) is applied to AbsVal function block 4, which provides its absolute value spd/sin(A)/. Similarly, spd×cos(A) is applied to a like AbsVal circuit to provide signal spd/cos(A)/. These respective signals are applied to low-pass filter circuits labeled 8, to provide a signal labeled spd normally proportional to speed, unless V_{dc} exceeds Ref. This signal spd is applied to multipliers 5 which provide outputs spd²/cos(A)/ and spd²/sin(A)/.

Substantially sinusoidal Ph.1 current feedback signal is applied to function block 4a in FIG. 2 (labeled AbsVal), to provide a signal variable for the absolute value of Ph.1 stator current: crnt amplitude /sin(A)/. Likewise, the Ph.2 stator current feedback signal is converted to Ph.2 stator crnt amplitude /cos(A)/. Each of these absolute value signals is applied to respective difference amplifiers, shown as sum function blocks 6. This signal processing provides negative current feedback, to respective minor feedback loops, whose outputs modulate respective PWM function blocks 7. The PWM circuits provide ON/OFF drive (Ph.1 PWM), to Q1 and Q2 in FIG. 1, for Phase 1 stator current control proportional to speed squared and ON/OFF drive (Ph.2 PWM) to Q3 and Q4 for Phase 2 stator current control that is likewise proportional to speed squared.

Abs Val function blocks 4 in FIG. 2 may be implemented by various circuits, depending upon respective signal dynamic range accuracy needed. Abs Val function blocks 4a that convert current feedback to absolute value require higher dynamic range than Abs Val blocks 4 because the negative feedback they provide to control stator current is essential, even at very low current levels, to maintain regulated stator current.

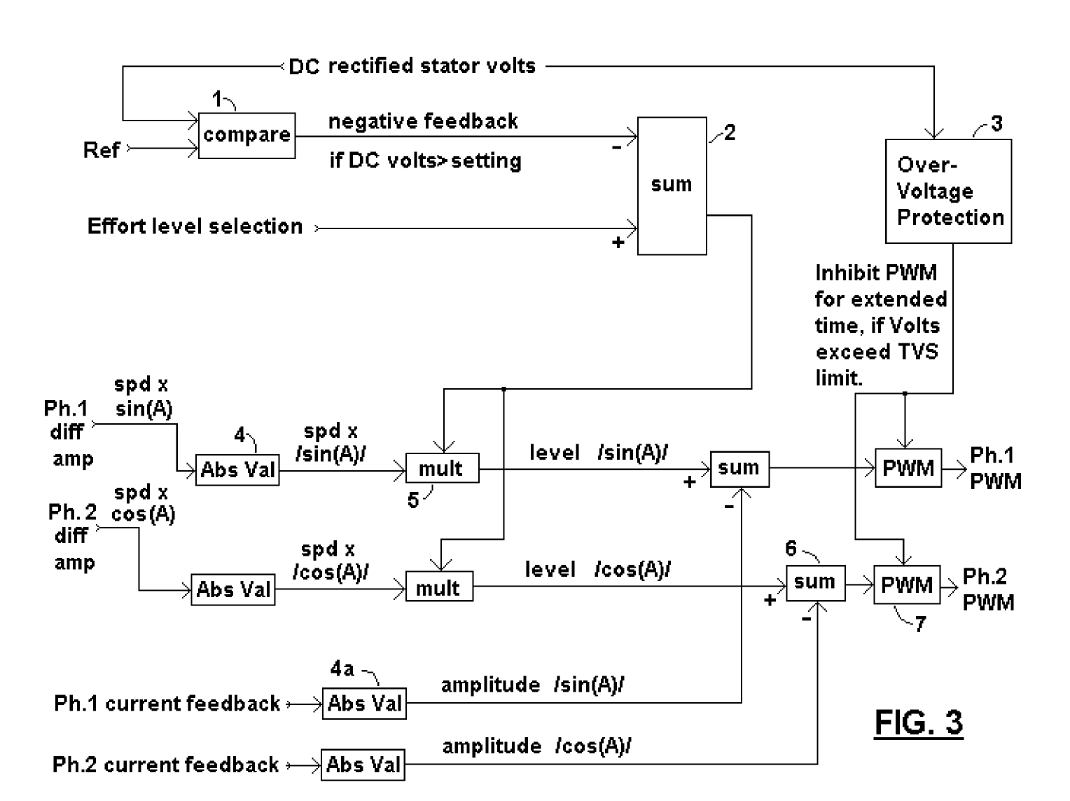

FIG. 3 illustrates a functional block diagram for the Power Control Electronics 5 in FIG. 1, which is intended for general applications. Like the circuit in FIG. 2, compare block 1 is also responsive to a reference command (Ref) and to the DC power bus voltage. However, in FIG. 3, the resulting negative voltage feedback is then compared by sum circuit 2 (which is preferably implemented by an operational amplifier circuit) with an Effort level selection signal. Abs Val block 4 likewise provides respective absolute value spd/sin(A)/ and spd/cos(A)/ signals from Ph.1 and Ph.2 differential amplifier stator voltage sensor output signals. Abs Val 4a circuits provide the absolute values of respective Phase 1 and Phase 2 current feedback signals, which serve as current feedback to respective sum 6 circuits, which are responsive to level commands from respective multiplier blocks 5. Thus, stator current level control is synchronized with respective stator winding voltage, by PWM blocks 7, which provide respective Ph.1 PWM and Ph.2 PWM high-frequency ON/OFF drive to Q1-Q2 and Q3-Q4 shown in FIG. 1.

Over-Voltage Protection (function block 3), shown in both FIG. 2 and FIG. 3, is a vital preferred element of the integrated electronics, which prevents damage from high voltage if the load connection is suddenly opened. The negative voltage feedback to block 1 is generally processed by electronics that incur too much delay to always prevent damage from over-voltage. Therefore, a Transient Voltage Suppressor (TVS) device that is commercially available from various suppliers conducts within pico-seconds whenever its conduction voltage is exceeded. The TVS is basically a very large junction area zener diode. Its thermal capacity, with parallel filter capacitors, is sufficient to absorb without damage all energy stored in inductors L1-L4 shown in FIG. 1. Whenever the TVS conducts, current through it is sensed by a circuit that inhibits PWM 7 from driving Q1, Q2, Q3, and Q4 for an extended time, thereby stopping the normal boost regulation of the generator electronics, and allowing sufficient time for TVS heat to dissipate. An output voltage feedback signal, which does not affect the current command signal proportional to speed squared unless the output voltage reaches a desired level, reduces the current command signal whenever output voltage reaches the desired voltage control limit. Therefore, this voltage control means, which controls pulse-width-modulation that regulates output voltage during normal operation, functions cooperatively with the transient voltage suppressor circuit, by shutting down boost-regulated output whenever output voltage exceeds the desired setting. Transient voltage suppression mainly needs to absorb energy stored in the series inductors, for time needed by normal output voltage control to respond.

Power from Ph.1 stator winding is effectively the root-mean-square value of its stator current multiplied by its rms stator voltage=(Ph.1 peak current)*(Ph.1 peak voltage)*(0.5). Likewise, Ph.2 power=(Ph.2 peak current)*(Ph.2 peak voltage)*(0.5). Since Ph.1 and Ph.2 are essentially equal in magnitude and time displaced by 90° phase relative to each other, the Ph.1 plus Ph.2 power sum is (peak current)*(peak voltage) of either Phase 1 or Phase 2.

Inasmuch as peak current and voltage of Ph.1 and Ph.2 are equal to each other, and each is sinusoidal with 90° relative phase, and sin²(A)+cos²(A)=1, and the sum of power from Ph.1 and Ph.2 equals power fed to the DC power bus I_{DC}*V_{DC}, then, for either phase: (peak stator current)*(peak stator voltage)=(I_{DC},*V_{DC}).

The above equation explains why controlling peak stator current so it is proportional to speed squared, when multiplied by peak stator voltage, which is proportional to speed, results in output power (I_{DC}*V_{DC}) proportional to the third power of speed. Coupling this generator to a wind turbine having blade pitch control or other means to limit its speed maximizes energy yield from the most prevalent winds, when power usually is most needed. It also protects the turbine from mechanical stress incurred by turbines that do not have said speed-limiting features, while still providing controlled DC electric power at levels its loads can accept.

Generator power and efficiency with wind turbine drive is computed below, for a representative example of the present invention, at maximum shaft speed, mid-speed, and minimum usable speed, using a few simplifying approximations. Shaft speed, power, and the other variables in the computations herebelow are exemplary, and not intended as limiting the present invention in any way. This will help explain FIG. 1 and FIG. 2 configuration operation, distinctions and improvements over widely used prior art generators:

Let maximum speed equal 1000 revolutions per minute (rpm), mid-speed equal 500 rpm, and minimum speed equal 100 rpm. Also, let maximum stator current Iₘₐₓ=10 amperes, and nominal V_{DC}=100 volts. Further, let Q1-Q4 power MOSFET ON resistance R_{dson}=0.01 ohm, inductor L1-L4 series pair winding resistance R_{L}=0.1 ohm. Also, stator winding resistance Rₛ=0.15 ohm, stator voltage Vₘₐₓ=100 volts at 1000 rpm, and fly-back (free-wheeling) diode D1-D8 forward drop V_{f}=1-volt at 10 amp. These parameters are consistent with a test prototype, according to the present invention, developed to generate power from wind turbines.

At 1000 rpm, Vₘₐₓ=100 volts, so PWM duty-cycle (Tₒₙ)/(Tₒₙ+T_{off}) is essentially zero. Therefore, losses=Iₘₐₓ²(R_{L}+Rₛ)+2 V_{f}Iₘₐₓ=(10 amp)²(0.25 ohm)+(2 volt)(10 amp), amounting to 45 watts loss. Output power=(Iₘₐₓ)*(Vₘₐₓ)=(Iₘₐₓ)*(V_{DC})=(10 amp)(100 volts)=1000 watts. So, generator efficiency at maximum speed and maximum power is about 95% for this example of generator and integrated electronics parameters.

At 500 rpm, Iₘₐₓ=(10 amp)/(4)=2.5 amps; and Vₘₐₓ=(100 volts)*(0.5)=50 volts. So PWM duty-cycle=½. Average pulse power generated=(Iₘₐₓ)*(Vₘₐₓ)=(Iₘₐₓ)*(V_{DC})/2=(2.5 amp)(50 volt)=125 watts. Losses to maintain inductor current=Iₘₐₓ²(R_{L}+Rₛ+Rₒₙ)=(2.5 amp)²(0.26 ohm)=1.6 watts. Fly-back diode losses=2 V_{f}*Iₘₐₓ/2=(0.6 v)(2.5 amp)=1.5 watts. So total losses=3.1 watts. Therefore, mid-speed generator efficiency is about 97%.

At 100 rpm, Iₘₐₓ=(10 amp)/(100)=0.1 amp; and Vₘₐₓ=(100 volts)/(10)=10-volts. So PWM duty-cycle= 9/10. Average pulse power generated=(Iₘₐₓ)*(Vₘₐₓ)=(Iₘₐₓ)*(V_{DC})/10=(0.1 amp)(10 v)=1 watt. Losses to maintain stator and inductor current=Iₘₐₓ²(R_{L}+Rₛ+2*R_{dson})=(0.1 amp)²(0.27 ohm)=0.0027-watt. Fly-back diode losses=(2*V_{f})*(Iₘₐₓ)/10=(0.6 v)(0.1 a)/5=0.012 watts. So total losses=0.015-watt. Thus, generator efficiency at low speed is about 98%.

Note that, although the generator according to the present invention is self-starting (so that it need not be connected to a power source, to begin power generation), the minimum speed of the above power and efficiency computation must be reached, before the signal processing electronics will function as required. Also, MOSFET gate driver under-voltage lockout should prevent PWM drive to Q1-Q4 in FIG. 1 until the minimum voltage of approximately 8-volts is reached. Moreover, a few watts is needed from the stator windings, rectified by D9-D12, which is used to supply Power Control Electronics 5.

At the lowest usable shaft speed of 100 rpm in the above representative example, the 10-volt peak stator voltage generated would be adequate for all signal processing and PWM drive electronics, so this generator would be self-starting when turbine speed reaches 100 rpm. However, with a few watts quiescent power for the Power Control Electronics, power supplied to the load at 100 rpm would be zero until wind speed increases to above 100 rpm.

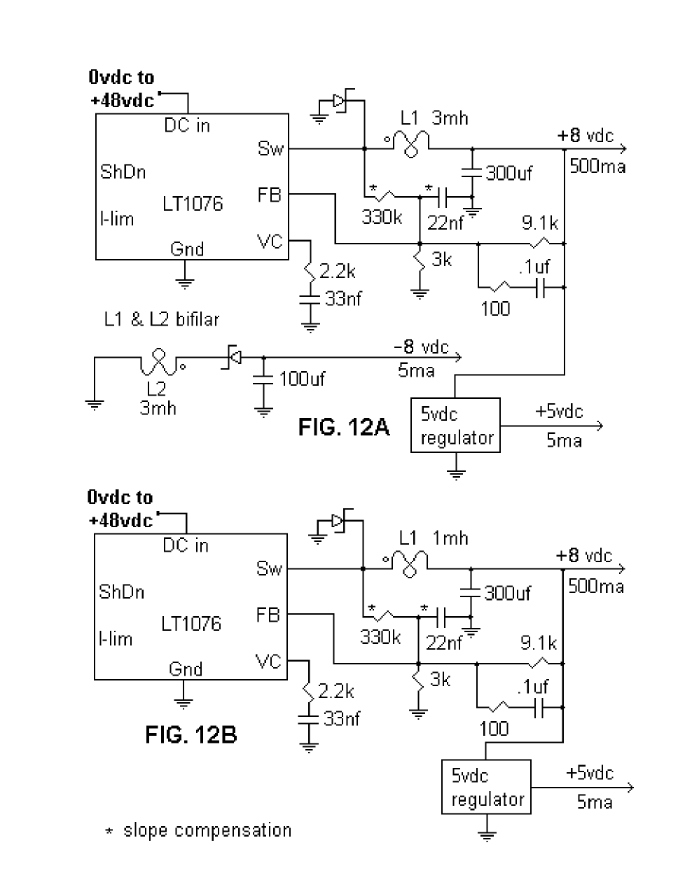

Note that, for uses requiring higher DC Power Bus voltages, power MOSFET drain-source ON resistance R_{dson} usually increases considerably with voltage rating. Moreover, power MOSFET voltage ratings beyond 500 volts begin to limit available fast power switching MOSFET options. Also, at DC power voltages higher than 50 volts, a substitute for the PWM regulator IC (Integrated Circuit) shown in FIG. 12A-B, having a higher input voltage rating, will be needed. Topswitch PWM buck regulator ICs, by Power Integrations Inc., are likely options, for both signal processing electronics and DC power current and voltage control. At DC power voltages higher than 500 volts, IGBTs (Insulated Gate Bipolar Transistors) would become a likely option, over MOSFETs (Metal Oxide Silicon Field Effect Transistors).

A main application, for the wind turbine generator shown in FIG. 1 and FIG. 2, would be as wind turbine DC generators for distributed on-site power systems, wherein the wind turbine maximum speed is limited. Said generators are also uniquely compatible with flywheel batteries described in applicant's U.S. Pat. Nos. 6,566,775 and 6,794,777. Said generator output current is DC and does not include significant current ripple components. Said flywheel batteries require DC input current and DC current loads, with essentially zero ripple components.

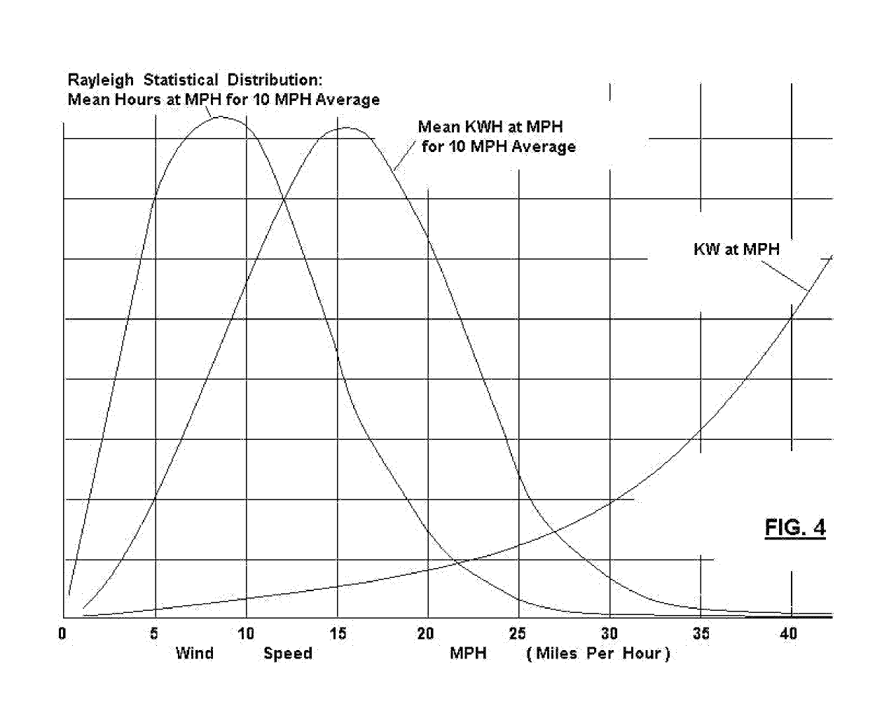

FIG. 4 illustrates available power (KW) from typical wind turbines, as a function of wind speeds from zero to 50 miles/hour (mph). Since turbine rotational speed is typically proportional to wind speed, and turbine torque is typically proportional to wind speed squared, available power from the turbine is typically proportional to wind speed cubed. FIG. 4 also shows, for a location with 10-mph average wind speed, the probable mean hours duration at each wind speed, known as a Rayleigh Statistical Wind Speed Distribution.

From the probable mean hours duration curve illustrated, note that the most probable wind speed (the prevailing wind speed present for the longest duration) is about 8-mph for a 10-mph average wind speed location, as shown. With turbine torque proportional to the second power of wind speed, torque at 8-mph is about ( 8/25)²=10% of available torque at 25-mph. With turbine power proportional to the third power of wind speed, power available at 8-mph is ( 8/25)³=less than 4% of available power at 25-mph. A torque of only 10% that at 25-mph (and less than 3% that at 50-mph) will usually not be enough to overcome speed-up gear friction and cogging torque, of commonly used prior art wind turbine generators. Moreover, prior art synchronous generators do not produce sufficient output voltage to feed typical loads, at wind speeds below about ⅓ maximum generating speed (over 16 mph for the example illustrated by FIG. 4). Therefore, most common prior art generators produce no useful power until their shaft speeds reach their rated speeds.

Moreover, induction machines connected to a 3-phase grid would draw power—not supply power—if connected at low wind speeds, and consequently, low shaft speeds. Besides that drawback, induction generators do not supply regulated power. Their power fluctuates with wind speed. Moreover, unless turbine speed is limited, heating and need for cooling increases as induction generator efficiency falls drastically at speeds only several percent above their maximum power speed. Conversely, the present invention can efficiently generate continuous high-quality power, at wind speeds here shown in a 5 to 50 mph range, which, with efficiency near 95% compared to less than 80% for most others, can yield at least double the energy from the same wind turbines, over most common prior art generators.

By multiplying KW at MPH by Mean Hours at MPH, we obtain the statistical distribution Mean KWH at MPH, which is illustrated in FIG. 4. Note that the Mean KWH at MPH curve is a maximum at about 16-mph. Moreover, note that the area under the curve Mean KWH at MPH, over the entire speed range is the statistically probable energy yield potentially available from typical wind turbines, over a usual 1-year time-period. Considering that common prior art generators, installed in locations like this example, cannot generate useful power at wind speeds under 16-mph, the area under the curve and therefore the potential harvested energy, at all wind speeds below 16-mph, is relinquished by them. That amounts to about half the total probable yearly energy potential of wind turbines. Power is also lost in their speed-up gears and generators at all wind speeds, amounting to over 10% of the potential turbine power. Moreover, oil and coolant pumps of widely used prior art generators add further power losses and costs. Consequently, total power lost by those generators amounts to over 25%.

Conversely, the present invention is intended to generate high quality power over, for example, a 5 mph to 50 mph wind speed range illustrated in FIG. 4, with total generator losses under 5% of the potential turbine power. The far wider wind speed range and higher efficiency of the present invention, compared to most prior art generators, can produce more than double the energy yield of those generators, from the same wind turbines. Power from the present generator invention is also higher quality, because it has ripple-free regulated DC current, has regulated voltage, is compatible with flywheel batteries that connect to a DC power bus, is compatible with photovoltaic solar panel installations, and is compatible with chemical battery charging. A high-voltage version would be compatible with polyphase DC-to-AC inverters to augment utility grid power.

Most importantly, for applications to augment grid power, the present invention produces power that need never be disconnected (unlike common intermittent wind-farm power, turned ON and OFF as wind speed fluctuates, by the switchgear of widely used prior art generators). Such unregulated power peaks and disruptions, by those prior art generators, have serious negative consequences; so most electric power utilities are reluctant to connect their grids to most prior art wind-powered generators. That fact limits their numbers and their markets.

Moreover, the present invention generator produces power at times when it is most useful, and does not incur nearly as much transmission line losses, because it can provide steady power at lower wind speeds, and regulated power at higher wind speeds, compared to the high and usually unregulated intermittent power of common prior art generators.

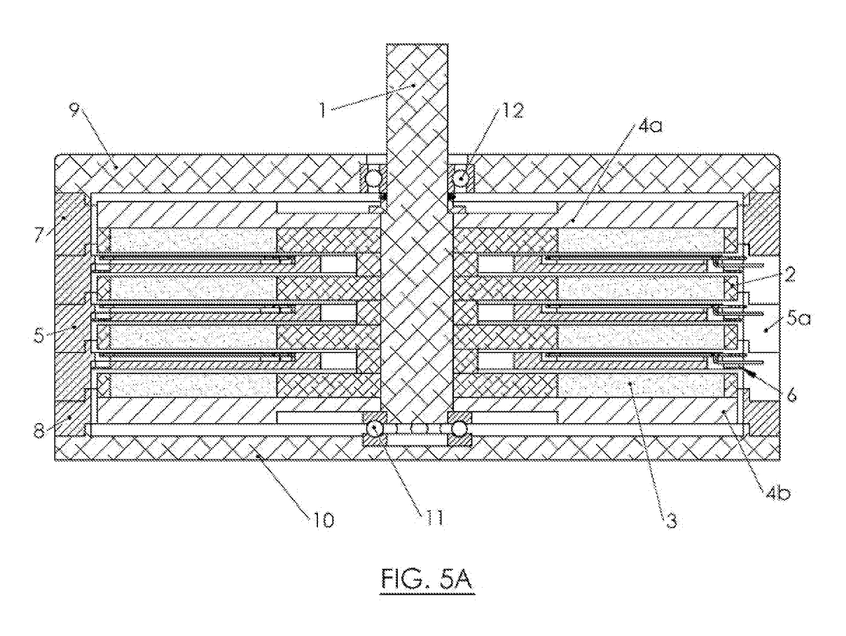

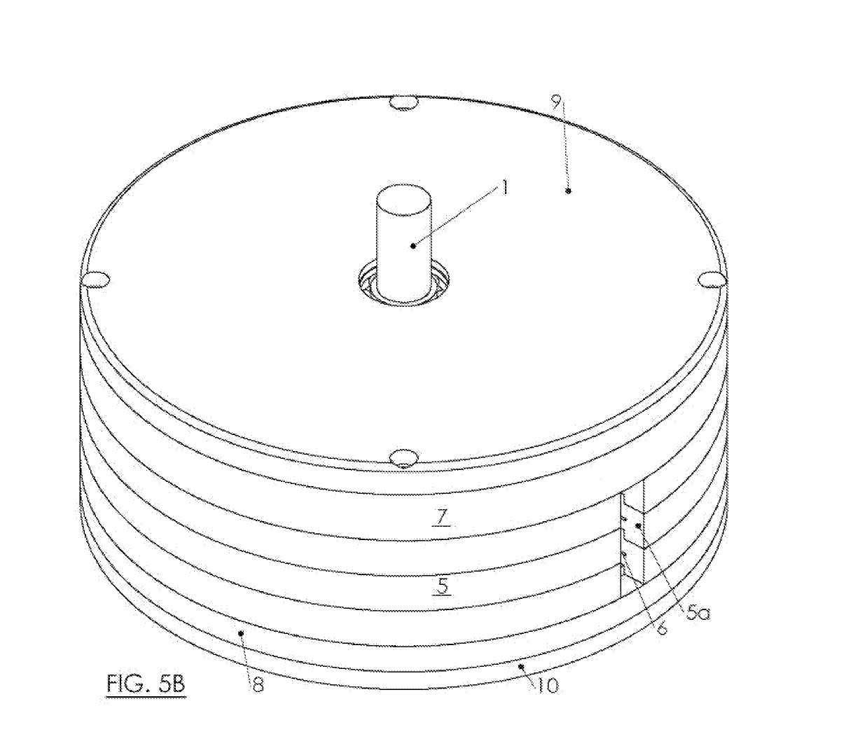

The cross-section view in FIG. 5A shows main elements of a vertical axis generator, according to the present invention. Rotational input power is typically supplied to it by a vertical axis wind turbine, having a power output shaft coupled to the generator shaft 1, by means of a flexible bellows coupling affixed to the respective shafts. A plurality of rotor magnet disks 2 closely fit around shaft 1, aligned therewith preferably by means of a key-way in shaft 1 and juxtaposed key-way grooves in each disk 2 inner diameter. Each rotor disk 2 supports a circular array of alternated pole axial-field magnets 3 attached therein. A return path, for the magnetic fields of magnets 3, in the disks 2 at each end, is preferably provided, for low cost, by high magnetic permeability iron disks 4a and 4b attached at each end of rotor disks 2. Rotor disks 2 are non-ferrous (e.g., aluminum) and have low magnetic permeability, to maximize flux density between the disks 2, which interacts with stator winding radial segments within stator disks 5. The stator disks 5 are preferably injection molded with the two stator windings they hold with their axially co-planar radial segments, and composed of a material that is electrically non-conductive, which has high thermal conductivity so that heat generated by current in the stator windings is conducted by the stator disk to adjoining thermally conductive generator assembly support structures, like an outer diameter casing or inner diameter tubular shaft.

Preferably two phases are included in the present invention. More phases would generally require more stator windings and more winding connections. One stator winding 6, of two held in each stator disk, is shown in cross-section FIG. 5A. The second stator winding axially abuts winding 6, and is disposed relative to winding 6 an angle 180 degrees divided by the number of poles. Radial segments of all stator windings in a stator disk are preferably formed so they will occupy the same axial plane, to facilitate a minimum axial gap between rotor magnets, and thus maximize the magnetic field interacting with the stator currents.

All rotor magnet disks 2 are preferably identical parts. All stator disks 5 are also preferably identical parts, including axial channel 5a for connecting their respective stator windings. Stator rings 7 and 8 facilitate axial alignment of radially abutted stator disks 5 and axial clearances between rotor magnet disks 2 and stator disks 5.

Top enclosure disk 9 and bottom disk 10 are preferably composed of a metal such as aluminum. Disk 10 supports preferably axial thrust ball bearing 11, which supports center shaft 1 axially and radially, at its lower end, while facilitating rotation about its center with minimal friction and drag torque. Top disk 9 supports preferably deep groove radial ball bearing 12, and facilitates a precise axial preload by accurate axial hold of its outer race, cooperative with a wave spring that exerts a prescribed axial preload on ball bearing 12.

FIG. 5B illustrates an orthographic projection view of the vertical axis generator. It shows exterior views of shaft 1; stator disk 5 with winding connection channel 5a; stator ring 7; and stator ring 8. It also shows enclosure top disk 9; bottom support and enclosure disk 10; and four drilled, tapped, counter-sunk holes, from top disk 9 through bottom disk 10, to hold the assembly together and maintain rotational alignment of all stator disks, with four fastener screws. When its shaft is coupled to a turbine shaft, relative radial alignment must be accurate.

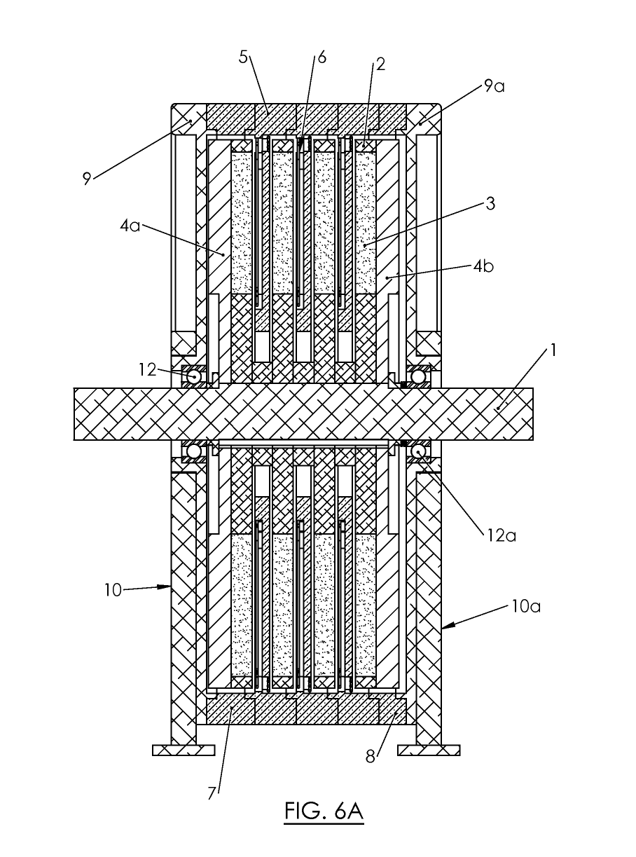

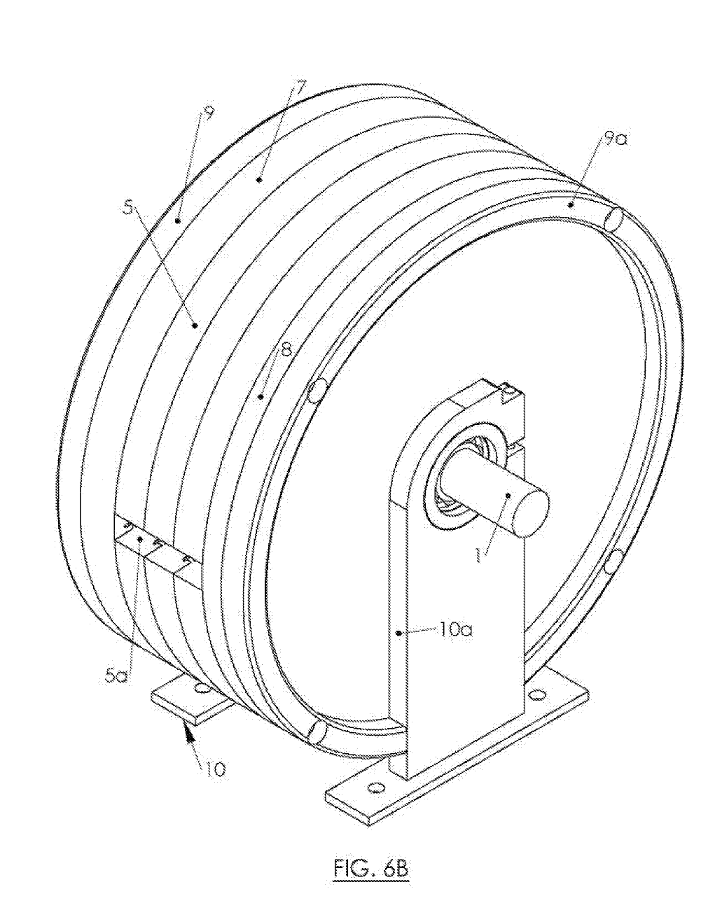

The cross-section view in FIG. 6A shows main elements of a horizontal axis generator, according to the present invention. Rotational input power is typically supplied to it by a horizontal axis wind turbine, having a power output shaft coupled to the generator shaft 1, by means of a flexible bellows coupling affixed to the respective shafts; or pedals may be attached at each end of shaft 1, for use in electric vehicles having an exercise option.

Like its vertical axis version, a plurality of rotor magnet disks 2 closely fit around shaft 1, aligned therewith preferably by means of a key-way in shaft 1 and juxtaposed key-way grooves in each disk 2 inner diameter. Each rotor disk 2 supports a circular array of alternated pole axial-field magnets 3 attached therein. A return path, for the magnetic fields of magnets 3, in rotor disks 2 at each end, is preferably provided by high magnetic permeability iron disks 4a and 4b attached at each end of rotor disks 2. Rotor disks 2 are non-magnetic and have low magnetic permeability, to maximize flux density between the disks 2, which interacts with current through stator winding radial segments within stator disks 5. The stator disks 5 are preferably injection molded with the two stator windings they hold, and composed of a material that is electrically non-conductive, which has high thermal conductivity so that heat generated by current in the stator windings is conducted to the disk and generator outer surfaces.

A lighter weight generator assembly embodiment that may cost more than the preferred embodiments is also contemplated. In that ironless generator embodiment, the iron disks 4a and 4b shown in FIG. 5A-5B would each be implemented by disk magnets that may have the same physical form as the iron disks. However, said disk magnets would need to be magnetized with axial poles aligned with the magnets affixed to the rotor disks, with a magnetic pattern between said axial poles that transitions between axial to tangential to axial, and so forth. Said magnetic pattern would provide a continuous flux path at each end of the rotor disks that substantially follows the same return flux path as the iron disks 4a and 4b. Because the two disk magnets are thereby disposed so they are not required to have high coercive force, they do not need to be rare earth magnets, which would be difficult to magnetize in said axial and tangential pattern. However, if thus magnetizing rare earth magnets such as Neodymium-Iron-Boron can be cost-effective, this contemplated embodiment would include replacing adjoining rotor magnet disks 2 and iron disks 4a and 4b by said magnets.

Like the vertical axis version, preferably two phases are included in the horizontal axis version. One stator winding 6, of the two, is shown in cross-section FIG. 6A. The second stator winding axially abuts winding 6, and is disposed relative to winding 6 an angle 180 degrees divided by the number of poles. Note that all rotor magnet disks 2 can be identical parts. Note also that all stator disks 5 can be identical parts, including axial channel 5a for connecting their respective stator windings. Stator rings 7 and 8 facilitate accurate axial alignment of radially interlocking stator disks 5 and accurate axial clearances with rotor magnet disks 2. Substantially all the elements described hereabove, and illustrated in FIG. 5A and FIG. 6A, for respective vertical and horizontal axis generator versions, are identical.

Left enclosure disk 9 and right enclosure disk 9a are preferably a metal such as aluminum. Disks 9 and 9a can be identical parts, except for machining to facilitate the four screws that hold the assembly together. Disk 9 holds the outer race of deep groove radial ball bearing 12. Right disk 9a holds the outer race of like ball bearing 12a. Their inner races support center shaft 1 axially and radially, while facilitating rotation about its center axis with minimal friction and drag torque. When assembled, a precise axial preload is facilitated, by accurate axial hold of the bearing outer races, cooperative with a wave spring that exerts a prescribed outward thrust on their inner races. This assembly is supported by brackets 10 and 10a.

FIG. 6B illustrates a projection view of the horizontal axis generator. It shows exterior views of shaft 1; stator disk 5 with winding connection channel 5a; stator ring 7; and stator ring 8. It also shows left disk 9; right disk 9a; and four drilled, tapped, counter-sunk holes, from disk 9a through disk 9, to hold the assembly together and maintain rotational alignment of all stator disks, with four fastener screws. Bracket 10 and 10a fastening details, and base support attachment, are also shown here.

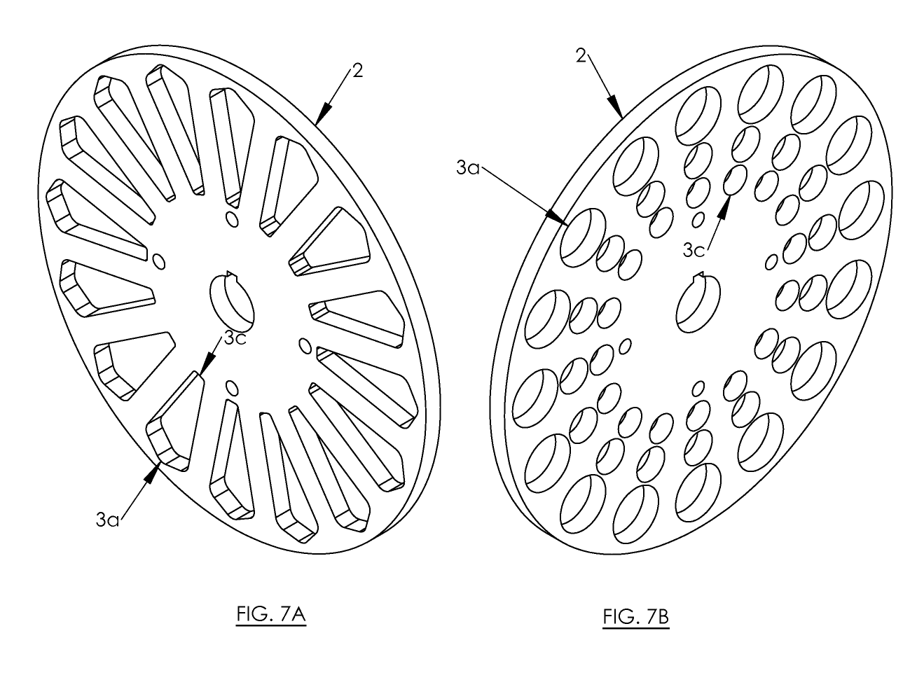

One of a plurality of non-ferrous rotor disks 2, to hold fastened by adhesive therein 16 (for example) axially magnetized, preferably Neodymium-Iron-Boron magnets, samarium-cobalt or other similar magnet materials, in an alternated pole array, is illustrated by orthographic projection FIG. 7A. The nearest magnet proximity to the rotation axis is here denoted 3c; the furthest proximity to the rotation axis is denoted 3a. Alternate rotor disk embodiment FIG. 7B is an option wherein three (for example) lower cost magnets constitute each magnetic pole.

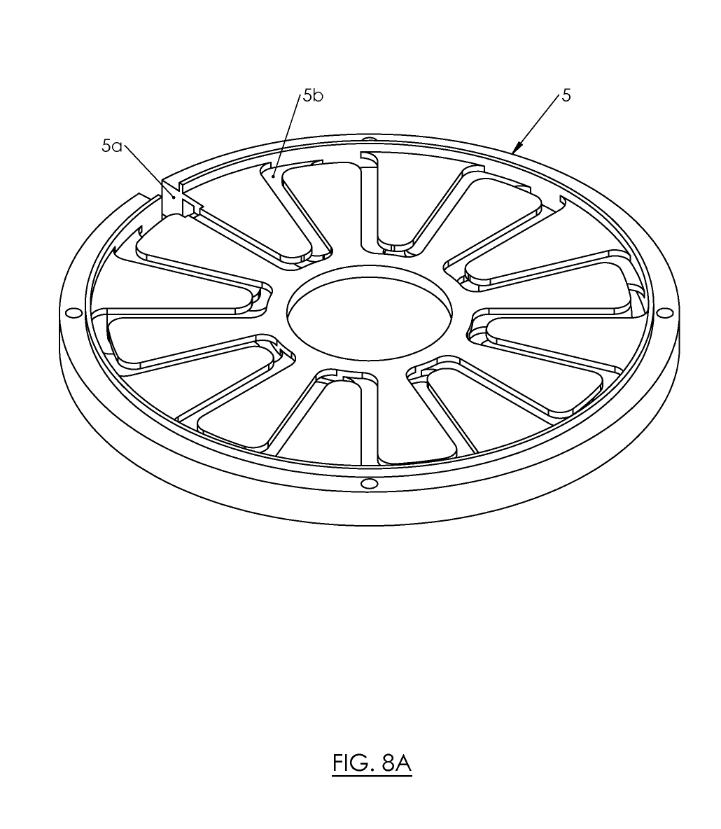

One of the cooperative stator disks 5 is illustrated by the orthographic projection FIG. 8A. Each stator disk holds preferably two stator windings, formed so their radial segments are in a single axial plane. A connection channel 5a is shown, for the winding terminals. Contiguous space 5b is shown for one of the two windings, and is partially visible for the second winding. Axial dimensions of stator disks 5, rings 7 and 8, plus other parts that determine axial positioning, are intended to maintain axial clearances between rotor relative to stator disks.

Two stator windings, 6 and 6a, each preferably formed from magnet wire with an insulating coating, having 3 series passes (also known as turns) in some generator embodiments according to the present invention, are shown in FIG. 8B. Stator winding radial segments 6r interact with the rotor magnetic field. Their current path is continued via outer arc segments 6co and inner arc segments 6ci, and via winding terminals 6t and 6ta. The two stator windings are abutted axially, and displaced 11.25 degrees, relative to each other, in the 16-pole stator disk shown in FIG. 8A. For a prototype generator, said stator disks are machined from bulk material that is electrically non-conductive; and pre-formed 2-phase stator windings are bonded within the recessed space shown. For production design generators, according to the present invention, the pre-formed stator windings, having radial segments in a single axial plane when arc segments are abutted, may be injection-molded within the space shown, with a thermally conductive resin available commercially from numerous suppliers.

Square cross-section preferably spiral Litz wire would be preferable compared to round magnet wire. A square cross-section facilitates more conductor area and therefore lower stator winding resistance, in an equivalent stator disk space. FIG. 8B illustrates similar stator wire forms for each respective phase, differing mainly in their respective conductor terminations 6t and 6ta. Clearly, the stator windings may have one or any prescribed number of turns, to generate desired voltage at a prescribed shaft speed, when connected in series with other stator disks in a generator assembly.

Stator conductor terminations, such as 6t and 6ta, are displayed having each of two terminals emerging from the stator disk outer diameter in FIG. 8B. Terminals 6t and 6ta are positioned for connection with an adjoining stator disk, or connection with power interface electronics, within channel 5a of FIG. 8A.

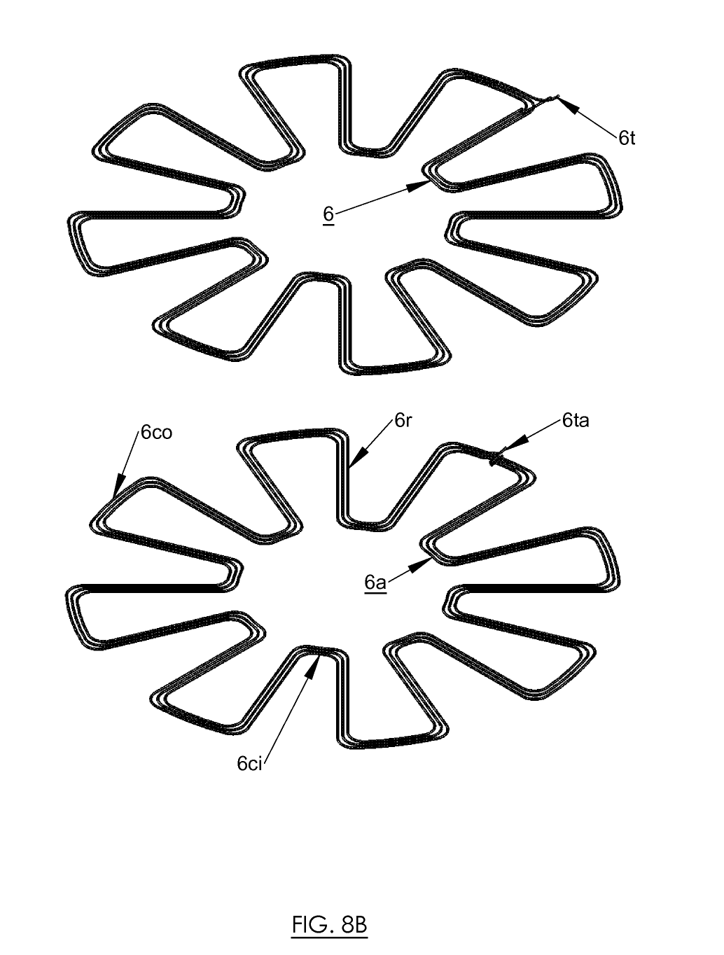

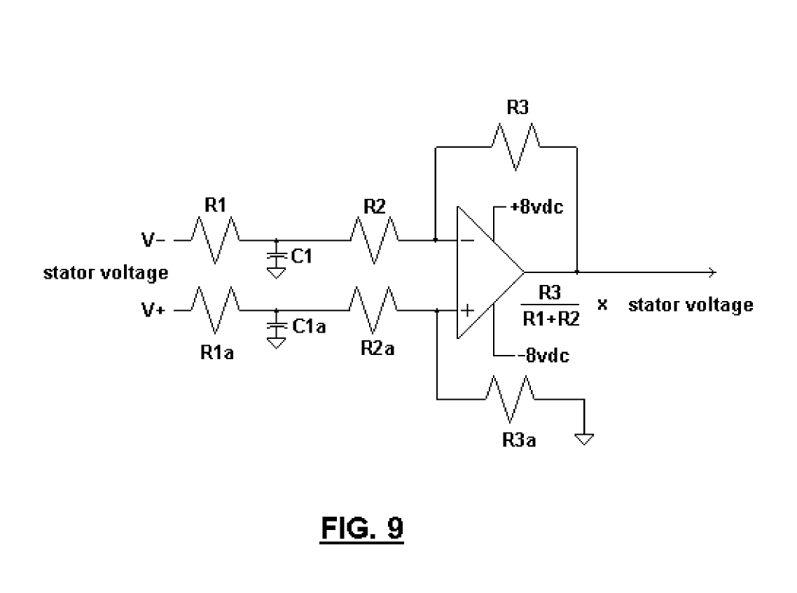

FIG. 9 illustrates a circuit schematic of a differential amplifier circuit intended to provide a feedback signal for processing, of voltage generated across a stator winding.

Voltage generated across respective 2-phase stator windings approximates Vₛ*sin(wt) and Vₛ*cos(wt). Amplitude Vₛ is proportional to speed and (wt) equals the product of said voltage frequency and time. For a 16-pole generator having a maximum 1000 rev/min speed, maximum stator voltage frequency would be (1000 rev/min)(8 cycles/rev)(min/60 sec)=133 cycles/sec. The differential amplifier of FIG. 9 includes means to reject relatively high common-mode voltage, compared to Vₛ, especially at low speed. This is achieved by closely matching pair R2=R2a and pair R3=R3a. Resistance of matched pair R1 and R1a is considerably less than matched pair R2 and R2a, so matching tolerance of R1 and R1a can be substantially less critical. For example, consider selecting R2=R2a=500,000 ohm, and R1=R1a=50,000 ohm. Then, if R2 needs to match R2a within 0.5% for sufficient common-mode rejection, R1 needs to match R1a to within 5% tolerance.

For a generator supplying controlled current to a 100 volts DC power bus, maximum stator voltage Vₛ is 100 volts peak. For generator signal processing electronics supplied +8 volts DC, −8 volts DC, and +5 volts DC, maximum operational amplifier output capability would be slightly less than 8 volts. Therefore, the differential amplifier of FIG. 9 would need its output to be less than [(8 v)/(100 v)][Vₛ*sin(wt)]. So with R2=500,000 ohm, R3=40,000 ohm.

Capacitors C1 and C1a cooperative with R1 and R1a are intended to reduce common-mode voltage at the operational amplifier inputs, from PWM square-wave pulses at, for example, 100,000 pulses/sec having substantially higher harmonic frequencies. With two inductors for each phase, as shown in FIG. 1, maximum square-wave pulse amplitudes are, for this example, (100 v)/2=50 volts peak-to-peak. A 4000 cycles/sec nominal frequency roll-off, from C1 and C1a equal to 750 picofarad for this example, will reduce said square-wave pulses, across C1 and C1a relative to signal ground, to roughly 2 volts peak-to-peak. Common-mode voltage at the two operational amplifier inputs would then be roughly (2 v)(R3)/(R2+R3)=0.15 volt peak-to-peak at 100,000 cycles/sec, with a third harmonic amplitude of 0.05 volt, fifth harmonic amplitude at 0.03 volt, and progressively lower amplitude at higher harmonic frequencies. Most integrated-circuit operational amplifiers can reject such low common-mode voltage at their inputs, so there would be virtually no output disturbance. Phase lag from C1-C1a to the highest frequency stator voltage feedback signal of 133 Hz for this embodiment example, is essentially negligible.

FIG. 12A shows a circuit schematic of a regulator circuit that produces a few watts at +8 v, −8 v, and +5 v for the Power Control Electronics. Its input power is provided by rectifier diodes D9-D12 shown in FIG. 1. The circuit schematic shown in FIG. 12B produces a few watts at +8 vdc and +5 vdc for Power Control Electronics that performs its signal conditioning with no negative supply. This regulator circuit starts at a lower input voltage, and the recently available integrated circuits using its output require less power, thus extending the generator speed range. Most of the power, provided by the +8 v output, is needed to drive the power MOSFET gates. That gate drive power, for each MOSFET, is equal to (Cgate)(PWM frequency)(gate voltage). Selecting a low gate drive voltage, consistent with adequate low R_{DSon}, will minimize gate drive power considerably. For example, gate drive power with +8 v gate drive is 45% of power with +12 v gate drive voltage.

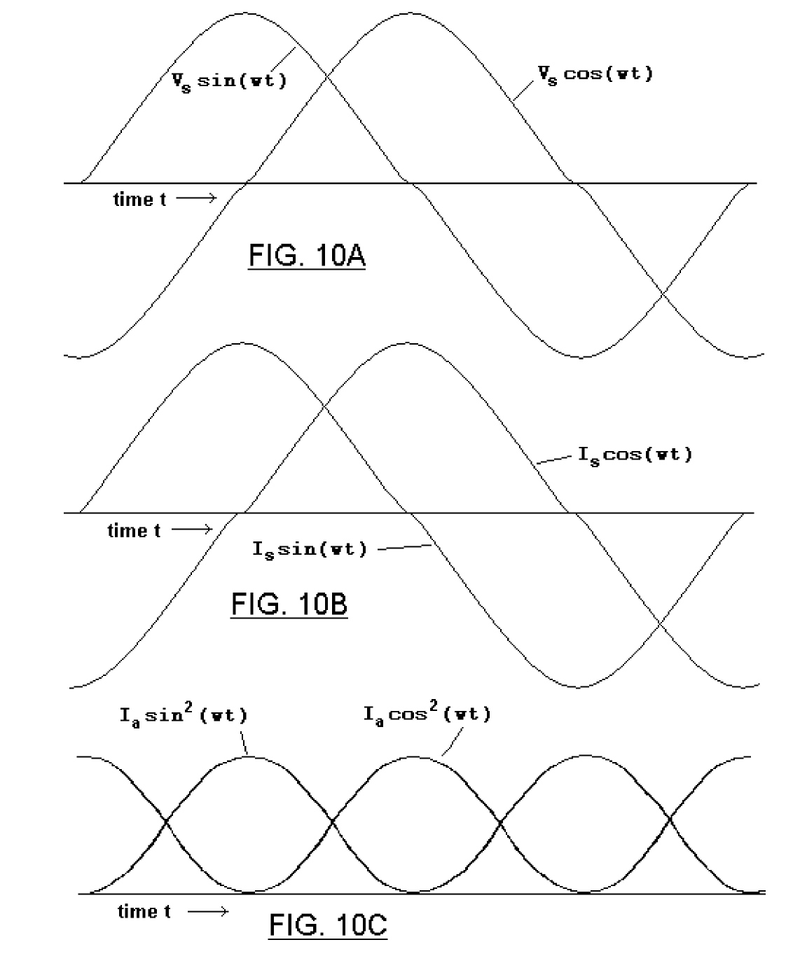

FIG. 10A illustrates typical stator voltage waveforms for a 2-phase generator, which can be approximated by Vₛ*sin(wt) for one phase and Vₛ*cos(wt) for the second phase.

FIG. 10B illustrates typical stator current waveforms for the 2-phase generator, controlled by the generator electronics switch-mode boost regulation circuit. These respective currents can be approximated by Iₛ*sin(wt) for one phase and Iₛ*cos(wt) for the second phase.

FIG. 10C illustrates resulting generator output current components after high-frequency pulse filtering Iₐ*sin² (wt) and Iₐ*cos² (wt), which is equal to Iₐ having minimal ripple, with a time base corresponding to FIG. 10A, which combine to provide DC current Iₐ fed to a DC voltage bus load. Said DC current can contain substantially zero ripple components, without need for large filter capacitors. For wind turbine generator signal processing electronics shown in FIG. 2, DC current Iₐ increases exponentially with the third power of speed.

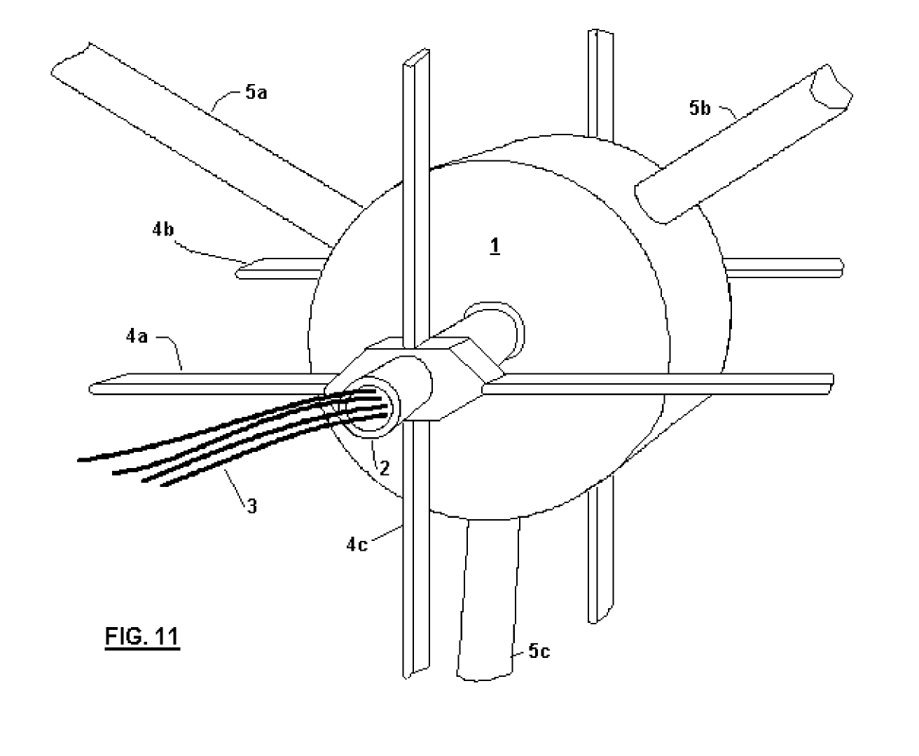

FIG. 11 illustrates a mechanical assembly 1 perspective view of a generator according to the present invention, to show a variation wherein the rotor disks extend to a rotatable outside diameter and the stator disks are affixed to a non-rotating tubular shaft 2 from which connections 3 to stator windings can be made. An integrated 3-blade axial wind turbine 5a, 5b, 5c and generator mechanical assembly 1 is shown. Generator shaft 2 is supported by structural members 4a, 4b, 4c intended to have minimal wind obstruction.

The FIG. 11 mechanical assembly variation facilitates an integrated wind turbine and generator. It requires less ball bearings than generators adapted to existing wind turbines, does not need a flexible shaft coupling between the generator and wind turbine, and consequently incurs less friction losses. Rotor disks modified from those shown in FIG. 7A-B, stator disks modified from those shown in FIG. 8A, and stator windings modified from those shown in FIG. 8B, would be required, to facilitate this variation and its benefits.

Modified versions of rotor and stator disks and stator windings have straightforward differences from FIG. 7A-B, 8A, 8B: For example, the rotor disk inside diameter would be larger, with no provision for it to hold a shaft. Moreover, the stator disk inside diameter would need mechanical attachment to the tubular shaft, similar to the keyway shown for the rotor disks shown in FIG. 7A-B. Moreover, the stator winding terminations would need to be accessible from the stator disk inside diameter, and would emerge from an end of its tubular shaft.

A motor-wheel application of the FIG. 11 generator mechanical assembly that includes two rotor angle sensors would enable lower cost, ultra-light electric vehicle regenerative propulsion having fewer drive components and less power losses than conventional prior art electric vehicles. For this application, each of the position sensors provides substantially constant peak amplitude sinusoidal rotor angle feedback signals to power electronics that control the motor. Accordingly, position feedback is available when motor rotational speed is zero and thus its stator winding voltage is also zero. Each sensor is aligned so its output signal is in phase with a corresponding stator winding voltage, as described in applicant's U.S. Pat. Nos. 4,085,355 and 4,520,300 for brushless regenerative DC motors.

Stator voltage due to generator shaft rotation can be computed from:

Vₛ(volts per radial segment)=Bₘₐₓ(weber/m²)*L(m)*v(m/sec).

Generator load torque due to stator winding current can be computed from:

Force(newton per radial segment)=Bₘₐₓ(weber/m²)*L(m)*I(amperes).

For a prototype generator constructed according to the present invention:

Bₘₐₓ=flux density at each radial segment when centered with a motor magnet
Bₘₐₓ=6000 gauss=0.6 weber/meter²
L=length of each wire segment (meters) in field Bₘₐₓ (see 3a and 3c in FIG. 7A-B)
Thus, L=magnet Rₒ−Rᵢ₌2.8 inch=0.07 meter (Rₒ=5.2 inch, Rᵢ=2.4 inch)
v=average velocity relative to field (meter/sec) at 1000 rpm shaft speed

Therefore, at 1000 rpm:

v=[2.pi]*[(Rₒ+Rᵢ)/2]/rev*[1000 rev/min]*(min/60 sec)=398 inch/sec=10 m/sec

Thus, at 1000 rpm:

Eₘₐₓ(volt/segment)=0.6 weber/m²*0.07 m*10 m/sec=0.42 volt

For 16-pole generator with 3 turns on each of 5 stator disks:

Total Eₘₐₓ at 1000 rpm=16*3*5*0.42 volt=100 volts.

Generated electric power=Eₘₐₓ*Iₘₐₓ=(100 volts)*(10 amp)=1-kilowatt.

For this example, the total for 5 stator disk windings connected in series, each #12AWG (which has 0.08 inch diameter, 1.6 ohm/1000 ft.), magnet wire length approximates 1000 inches (about 80 feet). So total stator winding resistance, of 5 windings connected in series, is about 0.15 ohm. Then, at 10-amp maximum current per phase, copper loss per phase approximates (10 amp)²/(2)*(0.15 ohm) which is approximately 7.5 watts. Therefore, total copper loss in the five stator disks of this example approximates 15 watts at 10 amperes DC current output. This loss amounts to 1.5% of shaft (mechanical input) power.

This stator voltage, power, and loss computation is important for optimally matching the generator to its intended DC power bus load voltage, calculating generated power, and for estimating power conversion efficiency and stator winding heat dissipation at various loads. Torque load of this 16-pole, 5 stator disks, 3 turns/disk generator, at 10 amperes DC load=(total forces on its stator winding radial segments)*(radius from rotational axis).

### Therefore:

Torque(ntn meter)=0.6 weber/m²*0.07 m*10 amp*0.096 m*16*3*5=9.6 ntn*m.

Mechanical Shaft Power=Torque*Speed=(9.6 ntn*m)*(1000 rev/min)*(6.28/rev)*(min/60 sec)*(1 watt)/(ntn*meter/sec)=1-kilowatt.

This torque and mechanical power computation is important for optimally matching the generator to its intended wind turbine or various other drivers, and for certification testing power conversion efficiency over the intended operating speed and torque range. The above simplified electrical and mechanical power computations do not include any loss factors. Therefore, the electrical and mechanical power computed above are equal for this example computation.

This is the maximum torque, caused by circumferential forces distributed evenly over each radial stator winding segment of one stator phase, in the rotor magnet axial field. The torque produced by the second stator phase is zero, when maximum at the other phase, because flux density at the second stator phase is then zero, and current through the second phase is also then zero. As the rotor spins, the sum of torques from the 2 phases, is constant. So there is no torque ripple, and no cogging torque mainly because the stator disks have no iron core that would tend to align at rotor angles where flux is maximum, as do prior art iron pole machines.

It should be noted from the above detailed generator geometry and computations, that relatively large generator diameters are needed, compared to prior art generators driven by low-speed wind turbines, to obviate need for speed-increase gearing. Therefore, present invention generator embodiments intended for horizontal-axis wind turbines will preferably include an aerodynamic nacelle (a substantially cone shape that minimally impedes air flow) at each end of the generator. Such nacelles can additionally provide secure housing for the generator integral electronics, protected from weather damage such as from rain, dust, and the like. They can also provide additional shielding to prevent weather damage, for the ball bearings at each end of the generator assembly. The design of this generator mechanical assembly can be sealed, because it does not rely on interior air flow for cooling, as do many prior art generators.

Note also the importance of obviating the need for speed-up gearing, and the zero cogging torque of the present invention generator: At low wind speeds, most prior art generator cogging torque, or speed-up gearing stiction and friction, usually causes wind turbines to stall at low wind speeds, because torque available at low wind speed is very low.

Lubrication needs for gears are usually higher and involve far more periodic maintenance, than lubrication needed by rolling element bearings. So maintenance costs are correspondingly higher, for most prior art generators, than will be needed by generators according to the present invention.

For both generators and wind turbines that drive them, it would be very beneficial if turbine shaft speed can be limited. Variable blade pitch is one preferable method to limit turbine speed. Wind diverters are good options. Sliding brake surface means, whereby braking action that limits speed is controlled by a centrifugal governor, is also an option. A shaft disconnect clutch is yet another option; however no power can be generated unless the turbine and generator are connected, and only the generator is protected by a shaft disconnect.

Power available from hydrodynamic sources such as flowing water is, like wind power, proportional to the third power of speed. So the same electronics signal processing of the primary embodiment of the present invention is also applicable to generators intended to maximize electric energy yields from variable-velocity water driven turbines.

Signal conditioning by analog circuits commonly needs both positive and negative DC supply voltages, which are frequently supplied by switch-mode PWM regulators like the circuit shown in FIG. 12A. To generate power over a broad speed range from wind turbines, said PWM regulators should start at a very low DC supply voltage, and function with very low power. The circuit shown in FIG. 12B starts at approximately half the voltage, and consumes approximately half the power, compared to the circuit shown in FIG. 12A. The inductor illustrated by FIG. 12B is also considerably smaller and lower cost. Therefore, FIG. 12B shows a preferred embodiment of said regulator. Slope compensation resistor and capacitor feedback circuits are identified in FIG. 12A-B, which add a feedback signal from the buck regulator integrated circuit PWM output to the feedback signal from the regulated +8 vdc output (which has high-frequency phase lags approaching 180 degrees, and therefore a tendency to cause oscillation that cannot be circumvented reliably by lead-lag compensation). Said PWM output does not incur said phase lags, and has an average value essentially equal to the +8 vdc output. Therefore, including said slope compensation does not degrade +8 vdc regulation. Because said slope compensation does not incur phase lag, it improves feedback loop stability considerably, and facilitates fast regulator settling time, by preventing oscillations. Additionally, the positive slope of said slope compensation pulse feedback reduces PWM jitter, which further improves performance.

Summarizing the hereinabove detailed description and its associated illustrations, a new wide-speed-range generator, and its various new subsystems, new element combinations, and new electronics, provided by the present invention, include:
(1) Differential amplifier stator voltage sensors, which provide a feedback signal of each respective stator voltage, processed by the integral electronics to control respective stator conductor current.
(2) Current sensors, to each provide a current feedback signal, corresponding to respective stator conductor current, for negative feedback loops that control the PWM circuits.
(3) Signal processing electronics, responsive to the stator voltages and stator current sensors, and to DC voltage feedback, to control stator current by PWM and thereby efficiently generate regulated DC current and voltage, from wide-speed-range rotational power, by boost regulation.
(4) Scalable combinations of the number of rotor and stator disks, and associated electronics, which facilitate a wide power range, without need for many different size parts and the tooling required to manufacture them.
(5) Preferably iron disks to provide return flux paths for the rotor magnets in the adjoining rotor disks. A lighter weight generator assembly may substitute permanent-magnet disks in place of the iron disks, which would essentially provide equivalent return flux paths.
(6) Stator voltage rectifier diodes that supply all power needed by the Power Control Electronics, including DC feedback voltage for DC output voltage control.
(7) An embodiment having rotor disks extending to the outside diameter, and stator disks attached to a tubular shaft from which the stator winding terminals emerge. Applicant's U.S. Pat. No. 4,520,300 for a Brushless Ultra-Efficient Regenerative Servomechanism and U.S. Pat. No. 7,646,178 for a Broad-speed-range Generator describe mechanical assemblies comprised of axial-field disk structures similar to those set forth herein. Their main difference compared to the structures set forth herein is the two Hall sensors installed within the assemblies described in those patents. The power interface electronics of each complete system can be substantially different, and can be further improved as new integrated circuit components become available, without incurring major expense. This consideration is important to the economics of a business enterprise manufacturing products from these related technologies. Moreover, generators having only power conductors facilitate installations.

While the foregoing detailed description of the present invention describes preferred embodiments, no material limitations to the scope of the claimed invention are intended. It will be understood that the present invention may have many variations in addition to those described by example herein, with appropriate embodiments using constituent elements to best suit a particular situation, application, or requirement. Further, features and design alternatives that would be obvious to one of ordinary skill in the art are considered to be incorporated herein. Accordingly, it is intended that the claims as set forth hereinafter cover all such applications, embodiments, and variations thereto within the true spirit and scope of this invention.

I claim as new and an improvement to the prior art, and desire to secure by Letters Patent:

1. A generator, including a coreless stator and rotor assembly, and integral power control electronics, for producing regulated DC current and voltage, from mechanical input power, over a broad range of shaft speeds, comprising:
stator disks holding poly-phase stator windings in a non-conductive non-magnetic matrix, axially juxtaposed with abutting conductor insulation, said windings angularly juxtaposed relative to each other 180° divided by the number of poles, said disks angularly aligned with a selectable number of like disks, that each produce across their windings a substantially sinusoidal voltage having amplitude and frequency proportional to rotational speed;
rotor disks holding a plurality of axially-magnetized alternating pole permanent-magnets, attached therein in a symmetrical circular array around an axis of rotation, said rotor disks angularly aligned with a selectable number of like disks numbering one more than the number of stator disks, the axial magnetic field from the rotor disks at the stator varying substantially sinusoidally with rotor angle;
differential amplifiers, responsive to the voltage across respective stator windings, to provide respective feedback of stator voltage for integral power control electronics; and
integral power control electronics, supplied by rectifier diodes from the stator windings, the electronics responsive to the stator voltage feedback signals from the differential amplifiers, and to a DC output voltage feedback signal, and to user settings, and to stator winding current feedback signals, for controlling current through the stator windings by high-frequency pulse-width-modulation, to provide DC power by filtered high-frequency boost-regulation, having regulated current and voltage, for a DC load, from mechanical power, over a broad range of speeds.

2. The generator of claim 1, wherein said integral power electronics in a generator embodiment intended to produce regulated DC current and voltage from wind turbines, with output power proportional to the third power of speed, over a broad speed range, further comprises:
means to compare a reference voltage setting with rectified DC voltage equal to DC output load voltage, and to provide a corrective signal if the reference setting is exceeded;
means to provide from sinusoidal and cosinusoidal stator voltage feedback signals, a signal having average amplitude proportional to rotor speed;
means to process the sinusoidal and cosinusoidal stator voltage feedback signals to provide their absolute values, and to multiply the respective absolute values by the average amplitude signal, for providing respective stator current command signals;
means to sense and process over a wide dynamic range, respective stator winding currents, to obtain respective stator winding current absolute values;
means to compare the respective stator current command signals, with the stator winding current signals, to provide respective PWM stator current control; and
over-voltage protection means, to inhibit PWM stator current output if DC output voltage exceeds a prescribed level.

3. The generator of claim 1, wherein said integral power control electronics in a generator embodiment intended to generate electric power from varied mechanical shaft power sources further comprises:
means to compare a reference setting level with DC voltage feedback, and to provide a corrective signal therefrom if the reference setting is exceeded;
means to compare said corrective signal with an effort level selection, to provide an effort level signal that optimizes generator output without exceeding the reference setting;
means to process the stator voltage sensor signals, to provide their respective absolute values, and to multiply the respective absolute values by the effort level signal, for providing respective stator current command signals;
means to sense and process over a wide dynamic range, respective stator winding feedback currents, to obtain respective stator winding current absolute value signals;
means to compare the respective stator current command signals, with the current absolute values, to provide respective PWM stator current control; and
over-voltage protection means, to inhibit PWM stator current output if DC output voltage exceeds a prescribed level.

4. The generator of claim 1, wherein said coreless stator and rotor generator assembly further comprises a vertical rotation axis and relatively large diameter, containing a plurality of rotor disks holding a relatively high number of poles intended to obviate speed-up gearing, to generate regulated DC current and voltage, over a wide speed range partly enabled by its zero cogging torque and absence of gear friction, from vertical-axis wind turbine shaft power.

5. The generator of claim 1, wherein said coreless stator and rotor generator assembly further comprises a horizontal rotation axis, to generate regulated DC current and voltage over a wide speed range partly enabled by its zero cogging torque and absence of gear friction, from horizontal-axis wind turbine shaft power.

6. The generator of claim 1, wherein said rotor disks further comprise axially magnetized permanent-magnets having contours to provide nearly sinusoidal flux variation with rotor angle, for the stator winding radial segments.

7. The generator of claim 1, wherein said coreless stator and rotor generator assembly further comprises stator disks having an electrically non-conducting matrix that is thermally conductive, to transfer heat from stator winding copper loss to the generator assembly outer diameter.

8. The generator of claim 1, including the electronics of claim 2, further comprising sliding brake surface means to limit shaft speed when otherwise not limited by a wind turbine coupled to its shaft, to provide continued regulated output power from the generator, during high winds that would otherwise result in shaft speeds beyond the generator regulated voltage range.

9. The generator of claim 1, further comprising at least one buck regulator in series with its DC output, to provide various regulated DC output voltages.

10. The generator of claim 1, further comprising a 3-phase inverter in series with its output, to provide regulated 3-phase power with minimal distortion and selectable phase.

11. The generator of claim 1, in further combination with a wind turbine having a shaft coupled to drive said generator, wherein a selectable number of rotor and stator disks is matched to said wind turbine, to optimize the wind turbine load for producing maximum generated electric power over a broad wind speed range.

12. The generator of claim 1, in further combination with a water turbine coupled to drive said generator, wherein said selectable number of rotor and stator disks is matched to said water turbine, to optimize the water turbine load for maximum generated power.

13. The generator of claim 1, in further combination with pedals to drive its shaft, installed in an electric vehicle, to provide a battery charger and recumbent cycling exercise option in the vehicle, that also extends the vehicle driving range.

14. The generator of claim 1, further comprising an iron disk at one end of the rotor disks and another iron disk at the opposite end, to provide return flux paths for the axial-field rotor magnets therebetween.

15. The generator of claim 1, further comprising a multi-pole magnetized disk at one end of the rotor disks and another multi-pole magnetized disk at the opposite end, to provide continuous axial and tangential flux path rotor magnets at each end, for an ironless generator embodiment.

16. The generator of claim 1, wherein its rotor disks are attached to a rotatable shaft coupled to its driver, the shaft supported by two ball bearings, its stator disks extending to its outer diameter from which its stator conductor terminals are accessed from a channel in its outer diameter.

17. The generator of claim 1, wherein its rotor disks extend to its outer diameter, and its stator disks are attached to a non-rotating tubular shaft from which the stator conductor terminals are accessed, the rotor assembly supported by a pair of ball bearings, one between the shaft at a first rotor end disk and the other between the shaft and the opposite end disk.
